(19) United States
(12) Patent Application Publication
(10) Pub. No.: US 2010/0266319 A1
(43) Pub. Date: Oct. 21, 2010

(54) HEAT GENERATION UNIT AND HEATING APPARATUS

(75) Inventors: Hiroaki Matsuoka, Kagawa (JP); Masanori Konishi, Kagawa (JP); Akira Nishio, Kagawa (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi (JP)

(21) Appl. No.: 12/742,634

(22) PCT Filed: Nov. 12, 2008
(86) PCT No.: PCT/JP2008/003280

§ 371 Date: May 12, 2010

(30) Foreign Application Priority Data
Nov. 16, 2007 (JP) 2007-297582
May 9, 2008 (JP) 2008-123408
Jul. 30, 2008 (JP) 2008-196138

(51) Int. Cl. G03G 15/20; H05B 3/20; H05B 3/10

(52) U.S. Cl. 399/330; 219/535; 219/553

(57) ABSTRACT

In a heat generation unit, an elongated sheet-like heat generator (1) having a carbon-based substance as a main component is structured such that a plurality of layers are laminated while forming an interval with each other in a thickness direction, current suppressing means (2) controlling a current flowing in each of the laminated layers is formed, the current suppressing means (2) is formed by providing a cut line by pressing a cutting tool in the thickness direction of the heat generator (1), and a current flowing in a longitudinal direction of the heat generator (1) can be controlled to a desired value by forming the current suppressing portion (2).

### TECHNICAL FIELD

The present invention relates to a heat generation unit used as a heat source of heating means and a heating apparatus using the heat generation unit, and more particularly to a heat generation unit using a heat generator formed in a sheet shape by employing a carbon-based substance as a main component and having an excellent heat generating property as a heat source, and a heating apparatus using the heat generation unit.

### BACKGROUND ART

As a heat generator having a carbon-based substance as a main component and used in a conventional heat generation unit, there is a structure disclosed in Japanese Unexamined Patent Publication No. 2006-049088. The heat generator disclosed in Japanese Unexamined Patent Publication No. 2006-049088 is constructed by a thin and elongated plate, and is structured such that power is supplied between both end portions in a longitudinal direction, and a plurality of slits cut in a direction which is orthogonal to the longitudinal direction are formed in each of both side edges along the longitudinal direction. These slits are cut from one edge in the both edges of the heat generator to just before the other edge, and the slits are arranged alternately in the longitudinal direction. In other words, a plurality of slits formed in the one edge side in the both edges of the heat generator and a plurality of slits formed in the other edge side are formed so as not to be opposed to each other, and are formed at shifted positions in the longitudinal direction.

Accordingly, the slit formed in the heat generator in the conventional heat generation unit is formed in a meandering shape along the longitudinal direction. In the slit formed in the heat generator which is meandering as mentioned above, an electric resistance of a whole of the heat generator can be decided by deciding a distance between the adjacent slits forming a current-carrying portion (hereinafter, referred to as a current flow path) to a desired length.

A band-like heat generator constructed by a carbon fiber and extending in a longitudinal direction is disclosed in Japanese Unexamined Patent Publication No. 2007-103292. In the heat generator disclosed in Japanese Unexamined Patent Publication No. 2007-103292 and constructed by the carbon fiber, a plurality of cut portions cut from one edge to a center line which is in parallel to the longitudinal direction while being orthogonal to the longitudinal direction are formed in each of both edges opposed to each other along the longitudinal direction. Further, these cut portions are formed in such a manner as not to disconnect a heat generation region that is the current flow path near the center line in the longitudinal direction of the heat generator. As a result, in the heat generator, each of the regions formed between the cut portions except the heat generation region serves as a heat dissipation region.

### Patent Document 1: Japanese Unexamined Patent Publication No. 2006-049088

### Patent Document 2: Japanese Unexamined Patent Publication No. 2007-103292

### Patent Document 3: Japanese Unexamined Patent Publication No. 2005-116412

### Patent Document 4: Japanese Unexamined Patent Publication No. 2005-149809

### DISCLOSURE OF THE INVENTION

### Problems to be Solved by the Invention

In the structure of a first conventional example disclosed in Japanese Unexamined Patent Publication No. 2006-049088, since the carbonaceous heat generator is provided with the slits alternately in the longitudinal direction thereof, a meandering current flow path having an approximately uniform flow path width is formed as the heat generation region. As mentioned above, in the first conventional example, the slits are formed within the limited plate surface of the thin and long heat generator in such a degree that a short circuit and a discharge phenomenon are hard to be generated, thereby forming the current flow path as long as possible so as to increase power consumption. However, in the structure of the first conventional example, in the case where a predetermined rigidity is not provided as the material of the heat generator, deflection and torsion tend to be generated in the heat generator due to formation of the slits. As a result, there is a risk that the short circuit, the discharge phenomenon and the like are generated and a problem is generated in quality.

Further, in a second conventional example disclosed in Japanese Unexamined Patent Publication No. 2007-103292, the heat generator is structured such that a heat generation region that is a current flow path is formed near a center line in a longitudinal direction, and a heat dissipation region is formed between the cut portions except the heat generation region. However, in the heat generator according to the second conventional example, since a boundary between the heat generation region and the heat dissipation region formed between the cut portions is indefinite, a resistance value in the longitudinal direction of the heat generator is scattered, and it is hard to accurately set the resistance value of the heat generator. As a result, in the heat generator according to the second conventional example, a problem is generated on a design of a product. Further, under an influence of the dispersion of the resistance value of the heat generator, a temperature dispersion is generated in the heat dissipation region, and a thermal stress is generated. In a worst case, there has been a risk that the carbon fiber constructing the heat generator is disconnected.

The present invention is made for solving the problems in the conventional examples, and an object of the present invention is to provide a heat generation unit which can form a current suppressing portion by applying a pressing force in a thickness direction and can obtain a stable and optional resistance value within a limited area of a heat generator, by using the sheet-like heat generator having a structure which has a carbon-based substance as a main component and is laminated in a thickness direction, and having a high coefficient of thermal conduction with an isotropic property in a surface direction. Further, an object of the present invention is to provide a heat generation unit which can obtain an accurate resistance value as a heat generator and has a great heat dissipation effect, by combining and arranging the current suppressing portions.

The present invention includes a heating apparatus, an image fixing apparatus and an image forming apparatus provided with the image fixing apparatus which use the heat generation unit as a heat source. The heating apparatus according to the present invention includes various apparatuses, for example, a heater device, an OA device such as a copying machine, a printer and the like, a heating cooking device, a drying machine, a humidifier and the like. Further, the image forming apparatus includes devices in which a heat source is necessary, for example, a copying machine, a facsimile, a printer, a complex machine having these functions and the like.

In an image forming process in the image forming apparatus, there is employed such an image fixing apparatus as to heat a member to be recorded carrying an unfixed toner image thereon, for example, paper at a high temperature as well as pressurizing so as to fix the image.

A heat generation unit is used as the heat source in the image fixing apparatus. The conventional heat generation unit used in the image fixing apparatus includes a halogen heater using a heat generator formed by a tungsten material, and a carbon heater using an elongated plate-shaped heat generator formed by a mixed material of a crystallized carbon such as a black lead or the like, a resistance value regulating material and an amorphous carbon (refer to Japanese Unexamined Patent Publication No. 2005-116412 and Japanese Unexamined Patent Publication No. 2005-149809).

The present invention provides an image fixing apparatus and an image forming apparatus having a heat source which can efficiently heat an object to be heated at a high temperature in accordance with a desired arranged heat distribution in a fixing process, which can rise quickly, and can lower energy consumption.

### Means for Solving the Problems

In order to solve the conventional problems mentioned above, a heat generation unit according to a first aspect of the present invention includes:

an elongated sheet-like heat generator generating heat by a voltage applied to both ends thereof in a longitudinal direction and having a carbon-based substance as a main component;

a holder holding the end portion of the heat generator;

a power supply portion supplying power to the both ends of the heat generator; and

a container including therein the heat generator, the holder and the power supply portion,

wherein the heat generator is structured such that a plurality of layers are laminated while forming an interval with each other in a thickness direction, and a current suppressing portion controlling a current flowing in each of the laminated layers is formed in the heat generator. The heat generation unit according to the first aspect of the present invention structured as mentioned above can obtain a stable and desired resistance value, and it is possible to provide a heat generation unit as a heat source having a long service life.

A heat generation unit according to a second aspect of the present invention is the heat generation unit according to the first aspect, wherein the current suppressing portion is constructed by a cut line in a direction which is orthogonal to a layer surface of the heat generator, and is formed in such a manner as to suppress the current flowing in a longitudinal direction of the heat generator. The heat generation unit according to the second aspect structured as mentioned above can obtain a stable and desired resistance value, and it is possible to easily provide a heat generation unit as a heat source having a long service life.

A heat generation unit according to a third aspect of the present invention is the heat generation unit according to the second aspect, wherein the current suppressing portion has a pair of first current suppressing portions extended from both opposed side edges of the heat generator toward edges opposed to each other in the heat generator, opposed end portions of the pair of first current suppressing portions are arranged so as to have a predetermined distance, and plural sets of the pair of first current suppressing portions are arranged along the longitudinal direction so as to have a predetermined distance. With the heat generation unit according to the third aspect of the present invention structured as mentioned above, it is possible to obtain a stable and desired resistance value within a limited heat generator area, and it is possible to provide a heat generator having a high wattage.

A heat generation unit according to a fourth aspect of the present invention is the heat generation unit according to the second aspect, wherein the current suppressing portion has a pair of first current suppressing portions extended from both opposed side edges of the heat generator toward edges opposed to each other in the heat generator, opposed end portions of the pair of first current suppressing portions are arranged so as to have a predetermined distance, and plural sets of the pair of first current suppressing portions are arranged along the longitudinal direction so as to have a predetermined distance, and

wherein a portion between the opposed end portions of the pair of first current suppressing portions becomes a center side conduction path having a predetermined width in a band width direction which is orthogonal to the longitudinal direction, and the center side conduction path becomes a current path in which the current flows along the longitudinal direction. With the heat generation unit according to the fourth aspect of the present invention structured as mentioned above, it is possible to obtain a stable and desired resistance value within a limited heat generator area, and it is possible to provide a heat generator having a high wattage.

A heat generation unit according to a fifth aspect of the present invention is the heat generation unit according to the second aspect, wherein the current suppressing portion has a first current suppressing portion extended from one edge of both opposed side edges of the heat generator toward the other edge of the heat generator, and a first current suppressing portion extended from the other edge of the both side edges toward the one edge, and the first current suppressing portions are arranged alternately so as to have a predetermined distance along the longitudinal direction. With the heat generation unit according to the fifth aspect of the present invention structured as mentioned above, it is possible to obtain a stable and desired resistance value within a limited heat generator area, and it is possible to provide a heat generator having a high wattage.

A heat generation unit according to a sixth aspect of the present invention is the heat generation unit according to the fourth aspect, wherein the current suppressing portion is structured such as to have a second current suppressing portion formed between the first current suppressing portions which are formed in plural sets while having a predetermined distance along the longitudinal direction, the first current suppressing portion and the second current suppressing portion are arranged alternately in the longitudinal direction, the second current suppressing portion is formed in such a manner that portions between both end portions thereof and the both side edges of the heat generator respectively become edge side conduction paths having predetermined distances, and the edge side conduction path becomes a current path in which a current flows along the longitudinal direction. Since the heat generation unit according to the sixth aspect of the present invention structured as mentioned above has a strength against a tension in the longitudinal direction of the heat generator and has elasticity due to a shape deformation, in the second current suppressing portion arranged in the center portion of the heat generator, the heat generation unit always follows the expansion and contraction of the heat generator generated by a heat cycle, and it is possible to prevent the heat generator from being disconnected.

A heat generation unit according to a seventh aspect of the present invention is the heat generation unit according to the sixth aspect, wherein the second current suppressing portion is formed in such a manner as to become shorter in accordance with coming close to the holder, near the end portion of the heat generator pinched by the holder, and a width of the edge side conduction path becomes wider in accordance with coming close to the holder. In the heat generation unit according to the seventh aspect of the present invention structured as mentioned above, since the width of the edge side conduction path by the second current suppressing portion becomes gradually wider in accordance with coming close to the holder, a stress is dispersed at the time of a drop, shock, oscillation and the like, so that it is possible to prevent the heat generator from being disconnected, and the heat generation unit is effective for preventing torsion of the heat generator.

A heat generation unit according to an eighth aspect of the present invention is the heat generation unit according to the sixth aspect, wherein a center portion near the center line in the heat generator is provided with a third current suppressing portion which intersects the second current suppressing portion, and is extended in the longitudinal direction. In the heat generation unit according to the eighth aspect of the present invention structured as mentioned above, since there are formed two conduction paths in which the current that the current flowing in the longitudinal direction is inhibited by the second current suppressing portion is defined by the third current suppressing portion, the current flows in the two conduction paths efficiently.

A heat generation unit according to a ninth aspect of the present invention is the heat generation unit according to the second aspect, wherein the current suppressing portion includes:

a first current suppressing portion extended from one edge of both opposed side edges of the heat generator toward the other edge of the heat generator; and

a third current suppressing portion coming into contact with the first current suppressing portion, and extended in the longitudinal direction, and

wherein a plurality of the first current suppressing portions and the third current suppressing portions are arranged at a predetermined distance along the longitudinal direction. Since the heat generation unit according to the ninth aspect of the present invention structured as mentioned above is structured such as to securely flow the current flowing in the longitudinal direction of the heat generator to the edge side conduction paths existing in the both edge sides of the heat generator by the third current suppressing portion, it is possible to secure the current path in which the current stably flows in the heat generator.

A heat generation unit according to a tenth aspect of the present invention is the heat generation unit according to the second aspect, wherein the current suppressing portion includes:

a second current suppressing portion extended so as to intersect in the longitudinal direction, and formed in such a manner as to have a predetermined distance with respect to the both side edges; and

a third current suppressing portion coming into contact with the second current suppressing portion, and extended in the longitudinal direction, and

wherein a plurality of the second current suppressing portions and the third current suppressing portions are arranged so as to have a predetermined distance along the longitudinal direction. Since the heat generation unit according to the tenth aspect of the present invention structured as mentioned above is structured such as to securely flow the current flowing in the longitudinal direction of the heat generator to the edge side conduction paths existing in the both edge sides of the heat generator by the second current suppressing portion and the third current suppressing portion, it is possible to secure the current path in which the current stably flows in the heat generator.

A heat generation unit according to an 11th aspect of the present invention is the heat generation unit according to the ninth aspect, wherein the current suppressing portion has the first current suppressing portion extended from the both opposed side edges of the heat generator toward the edges opposed to each other of the heat generator and formed in the both side edge sides of the heat generator while having a predetermined distance along the longitudinal direction, and a third current suppressing portion coupled to a center side end portion of the first current suppressing portion and extended so as to have a predetermined length in the longitudinal direction, and

wherein opposed regions of the third current suppressing portion become a center side conduction path, and the center side conduction path becomes a current path in which the current flows along the longitudinal direction. Since the heat generation unit according to the 11th aspect of the present invention structured as mentioned above is structured such as to form the center side conduction path by the third current suppressing portion, it is possible to secure the current path in which the stable current flows in the heat generator.

A heat generation unit according to a 12th aspect of the present invention is the heat generation unit according to the tenth aspect, where in a plurality of current suppressing portions each having the second current suppressing portion, and the third current suppressing portion coupled to both end portions of the second current suppressing portion so as to be extended in the longitudinal direction are arranged so as to have a predetermined distance along the longitudinal direction, whereby a row is constructed, the current suppressing portions are arranged in a single row or a plurality of rows in the longitudinal direction, a region between the third current suppressing portion and the edge of the heat generator, or a region between the rows when a plurality of rows are arranged is formed so as to become a conduction path having a predetermined distance, and the conduction path becomes a current path in which the current flows along the longitudinal direction. In the heat generation unit according to the 12th aspect of the present invention structured as mentioned above, since the second current suppressing portion and the third current suppressing portion are formed at the position at which a strain is hard to be generated with respect to the heat generator, it is possible to provide the heat generation unit having excellent stability with respect to a torsion and a deformation of the heat generator.

A heat generation unit according to a 13th aspect of the present invention is the heat generation unit according to the 11th aspect, wherein the first current suppressing portions formed in the both opposed side edge sides of the heat generator are formed alternately in the longitudinal direction in place of opposed positions, and the third current suppressing portions in both sides coupled to the first current suppressing portions so as to form the center side conduction path are formed alternately in the longitudinal direction in place of the opposed positions. In the heat generation unit according to the 13th aspect of the present invention structured as mentioned above, since the first current suppressing portion and the third current suppressing portion are arranged alternately along the longitudinal direction, it is possible to set a more stable resistance value. As a result, according to the heat generation unit of the 13th aspect, it is possible to provide a heat generation unit in which a dispersion of a temperature distribution of the heat generator is small.

A heat generation unit according to a 14th aspect of the present invention is the heat generation unit according to the 11th aspect, wherein on an assumption that an adjacent distance in the longitudinal direction of the first current suppressing portions provided on the same edge is set to L2, and a distance between adjacent end portions of the end portions extended in the longitudinal direction of the third current suppressing portion is set to L1, a relationship between L1 and L2 is a range that L1/L2 equals to or more than 0.2 and equals to or less than 0.9. With the heat generation unit according to the 14th aspect of the present invention structured as mentioned above, it is possible to provide a heat generation unit which can achieve a heat dissipation having high efficiency.

A heat generation unit according to a 15th aspect of the present invention is the heat generation unit according to the 11th aspect, wherein in a region near the holder in the heat generator, the third current suppressing portion is coupled to the center side end portion of the first current suppressing portion via a fourth current suppressing portion, the fourth current suppressing portion is formed so as to be inclined with respect to the longitudinal direction, and the center side conduction path in the region near the holder is constructed to be wider. With the heat generation unit according to the 15th aspect of the present invention structured as mentioned above, it is possible to form a temperature gradient in a region near the holder in the heat generator, it is possible to prevent a local thermal stress from being generated in the heat generator, and it is possible to provide a heat generation unit having a long service life.

A heat generation unit according to a 16th aspect of the present invention is the heat generation unit according to the third aspect to the eighth aspect, the 11th aspect, the 13th aspect and the 14th aspect, wherein in a region near the holder in the heat generator, a distance between the opposed end portions of the pair of first current suppressing portions is formed in such a manner as to become shorter in accordance with coming close to the holder, and a width in a band width direction of the center side conduction path pinched by the opposed end portions of the pair of first current suppressing portions is constructed in such a manner as to become wider in accordance with coming close to the holder. In the heat generation unit according to the 16th aspect of the present invention structured as mentioned above, since the width of the center side conduction path formed in the opposed end portion sides of the pair of first current suppression portions becomes gradually wider in accordance with coming close to the holder, it is possible to prevent the heat generator from being disconnected by dispersing the stress generated at the time of the drop, the shock, the oscillation and the like, and the structure is effective for preventing torsion of the heat generator.

A heat generation unit according to a 17th aspect of the present invention is the heat generation unit according to the first aspect, wherein the heat generator has a two-dimensional isotropic thermal conductivity in a layer surface direction. With the heat generation unit according to the 17th aspect of the present invention structured as mentioned above, it is possible to provide the heat generation unit as a heat source having a long service life.

A heat generation unit according to an 18th aspect of the present invention is the heat generation unit according to the first aspect, wherein the heat generator is structured such that plural layers of film sheet raw materials are laminated, and is formed in a sheet shape having a thickness equal to or less than 300 μm. Since the heat generation unit according to the 18th aspect of the present invention structured as mentioned above can change the resistance value of the heat generator by regulating the number of layers of the laminated film sheet raw material, it is easy to control power consumption.

A heat generation unit according to a 19th aspect of the present invention is the heat generation unit according to the first aspect, wherein the container is constructed by any one of a glass tube having a heat resistance and a ceramic tube, and is constructed by charging an inert gas into the container. Since the heat generation unit according to the 19th aspect of the present invention structured as mentioned above can suppress the reaction between the heat generator and a component such as oxygen or the like in an air which is generated upon energization or the like, by the inert gas charged within the container, the heat generator becomes a heat source having high quality and high reliability. Further, with the heat generation unit according to the 19th aspect of the present invention, it is possible to generate heat having a high temperature by the inert gas charged within the container, even in the case where the heat generator is made of such a material that reacts with the component such as the oxygen or the like in the air so as to easily burn even with heat generation at a low temperature.

A heating apparatus according to a 20th aspect of the present invention employs the heat generation unit according to the first aspect to the 19th aspect mentioned above as a heat source. The heating apparatus according to the 20th aspect of the present invention structured as mentioned above can obtain a stable and desired resistance value, and becomes a heating apparatus having a stable quantity and a high reliability by an effect of the heat generation unit as the heat source having a long service life.

An image fixing apparatus according to a 21st aspect of the present invention includes:

a heating body heating a member to be recorded in which an unfixed toner image is carried; and

a pressurizing body arranged so as to be opposed to the heating body and pressurizing the heating body via the member to be recorded,

wherein the heating body has a heat generator as a heat source, and the heat generator is formed in an elongated band shape in which plural layers of film sheet raw materials are laminated by a material including a carbon-based substance, and has a two-dimensional isotropic thermal conductivity. The image fixing apparatus according to the 21st aspect of the present invention structured as mentioned above has a quick rising edge, and can reduce energy consumption.

An image fixing apparatus according to a 22nd aspect of the present invention is the image fixing apparatus according to the 21st aspect, wherein the heat generator has such a structure having an interval between the layers formed by the material including a carbon-based substance. The image fixing apparatus according to the 22nd aspect of the present invention structured as mentioned above has a quick rising edge, and can heat the member to be recorded at high efficiency according to a desired heat arrangement distribution, and it is possible to achieve highly reliable image fixing.

An image fixing apparatus according to a 23rd aspect of the present invention is the image fixing apparatus according to the 22nd aspect, wherein the heat generator has such a positive characteristic that a value of a rate of resistance change obtained by dividing a value of a resistance at a balanced lighting state brought by energization by a value of a resistance at a non-energized state is in a range between 1.2 and 3.5, and a temperature of the heat generator and the resistance value are proportional. The image fixing apparatus according to the 23rd aspect of the present invention structured as mentioned above has a quick rising edge, and can heat the member to be recorded precisely at high efficiency according to a desired heat arrangement distribution.

An image fixing apparatus according to a 24th aspect of the present invention is the image fixing apparatus according to the 23rd aspect, wherein the heat generator may be constructed by a thin membrane body in which a thickness is equal to or less than 300 μm. The image fixing apparatus according to the 24th aspect of the present invention structured as mentioned above can carry out a fixing process while reducing energy consumption, by using a heat source in which a heat capacity is small and a rising edge is quick.

An image fixing apparatus according to a 25th aspect of the present invention is the image fixing apparatus according to the 23rd aspect, wherein the heat generator may be constructed by a light membrane body in which a density is equal to or less than 1.0 g/cm³. The image fixing apparatus according to the 25th aspect of the present invention structured as mentioned above can carry out a fix process while reducing energy consumption, by using a heat source in which a heat capacity is small and a rising edge is quick.

An image fixing apparatus according to a 26th aspect of the present invention is the image fixing apparatus according to the 23rd aspect, wherein the heat generator may be formed by a material in which a coefficient of thermal conductivity is equal to or more than 200 W/m·K. In the image fixing apparatus according to the 26th aspect of the present invention structured as mentioned above, since the heat generator has an excellent heat conduction, it is possible to carry out a heating process in a uniform heat arrangement distribution.

An image fixing apparatus according to a 27th aspect of the present invention is the image fixing apparatus according to the 23rd aspect, wherein the heating body may have a container storing apart of a power supply portion supplying power in both opposed ends of the heat generator together with the heat generator, and the container is structured such as to be filled with an inert gas in an inner portion and be sealed in the power supply portion. The image fixing apparatus according to the 27th aspect of the present invention structured as mentioned above becomes an image fixing apparatus having a heat source having a high reliability, and can carry out a heating process efficiently at a high temperature according to a desired heat arrangement distribution.

An image fixing apparatus according to a 28th aspect of the present invention is the image fixing apparatus according to the 23rd aspect, wherein the heating body is provided with a reflective portion for defining a heating region by the heat generator. The image fixing apparatus according to the 28th aspect of the present invention structured as mentioned above can heat the heating region efficiently at a high temperature according to a desired heat arrangement distribution, and it is possible to carry out a fixing process having a high reliability.

An image fixing apparatus according to a 29th aspect of the present invention is the image fixing apparatus according to the 23rd aspect, wherein the heating body may be provided with a plurality of the heat generators, and respective center axes in a longitudinal direction in the plurality of heat generators may be arranged on a straight line so as to be orthogonal to a conveying direction of the member to be recorded. The image fixing apparatus according to the 29th aspect of the present invention structured as mentioned above can switch the heating region in correspondence to the member to be recorded, and can specify efficient heating having a high temperature to a desired region.

An image fixing apparatus according to a 30th aspect of the present invention is the image fixing apparatus according to the 23rd aspect, wherein the membrane body may be formed by a member absorbing an infrared ray in an opposed surface to the heat generator, in the heating body. In the image fixing apparatus according to the 30th aspect of the present invention structured as mentioned above, since the heating body absorbs the heat from the heat generator at high efficiency, and can achieve heating having a high temperature and high efficiency with respect to the member to be recorded.

An image fixing apparatus according to a 31st aspect of the present invention is the image fixing apparatus according to the 23rd aspect, wherein the heating range of the heat generator may include a nip portion as a pressing position of the member to be recorded by the heating body and the pressurizing body, and an upstream side position in the conveying direction of the member to be recorded by the nip portion. The image fixing apparatus according to the 31st aspect of the present invention structured as mentioned above can carry out an image fixing process securely at high efficiency.

An image forming apparatus according to a 32nd aspect of the present invention is provided with the image fixing apparatus in any of the 21st aspect to the 31st aspect mentioned above. The image forming apparatus according to the 32nd aspect of the present invention structured as mentioned above can heat the member to be recorded that is the heated body at a high temperature with a desired heat arrangement distribution, has a quick rising edge, and it is possible to carry out heating control having a high precision while reducing an energy loss.

### EFFECTS OF THE INVENTION

In the heat generation unit according to the present invention, in a heat generator in which a plurality of layers are laminated while forming an interval with each other in a thickness direction, there is formed current suppressing means controlling a current flowing in each of the layers. Accordingly, it is possible to easily set a resistance value of the heat generator, and it is possible to provide a heat generation unit in which a heat dissipating effect in the thickness direction of the heat generator is satisfactory, a temperature distribution in the heat generator is small, and a service life is long.

Further, the heating apparatus having a high reliability can be constructed by using the heat generation unit according to the present invention, and it is possible to provide the image fixing apparatus and the image forming apparatus having the heat source having the high efficiency which can heat the member to be recorded that is the heated body at a high temperature according to the desired heat arrangement distribution. Particularly, in the case of using the heat generation unit according to the present invention, it is possible to provide the image fixing apparatus and the image forming apparatus which has a quick rising edge and can carry out the fixing process having reduced energy consumption.

### BRIEF DESCRIPTION OF THE DRAWINGS

FIG. 1 is a perspective view showing a heat generation unit according to embodiment 1 of the present invention.

FIG. 2 is a plan view showing a heat generator in the heat generation unit according to embodiment 1.

FIG. 3 is a cross sectional view showing one state of a current suppressing portion of the heat generator in the heat generation unit according to embodiment 1.

FIG. 4 is a cross sectional view showing another state of the current suppressing portion of the heat generator in the heat generation unit according to embodiment 1.

FIG. 5 is a cross sectional view showing further another state of the current suppressing portion of the heat generator in the heat generation unit according to embodiment 1.

FIG. 6 is a plan view showing the current suppressing portion of the heat generator in the heat generation unit according to embodiment 1.

FIG. 7 is a front view showing the current suppressing portion of the heat generator in FIG. 6.

FIG. 8 is a plan view showing a portion near a holder of the heat generator in the heat generation unit according to embodiment 1.

FIG. 9 is a front view showing a portion near the holder of the heat generator in FIG. 8.

FIG. 10 is a plan view showing a portion near a holder of a heat generator in a heat generation unit according to embodiment 2 of the present invention.

FIG. 11 is a plan view showing a heat generator in a heat generation unit according to embodiment 3 of the present invention.

FIG. 12 is a plan view showing a heat generator in a heat generation unit according to embodiment 4 of the present invention.

FIG. 13 is a plan view showing a portion near a holder of a heat generator in a heat generation unit according to embodiment 5 of the present invention.

FIG. 14 is a front view showing a portion near the holder of the heat generator in FIG. 13.

FIG. 15 is a plan view showing a heat generator in a heat generation unit according to embodiment 6 of the present invention.

FIG. 16 is a plan view showing a heat generator in a heat generation unit according to embodiment 7 of the present invention.

FIG. 17 is a plan view showing a heat generator in a heat generation unit according to embodiment 8 of the present invention.

FIG. 18 is a plan view showing a heat generator in a heat generation unit according to embodiment 9 of the present invention.

FIG. 19 is a plan view showing a heat generator in a heat generation unit according to embodiment 10 of the present invention.

FIG. 20 is a plan view showing a heat generator in a heat generation unit according to embodiment 11 of the present invention.

FIG. 21 is a perspective view showing one example of a heating apparatus according to embodiment 12 equipped with the heat generation unit according to the present invention.

FIG. 22 is a view showing a main structure in an image fixing apparatus according to embodiment 13 equipped with the heat generation unit according to the present invention.

FIG. 23 is a plan view showing a heat generation unit in the image fixing apparatus according to embodiment 13.

FIG. 24 is a side view of the heat generation unit in FIG. 23.

FIG. 25 is a temperature characteristic diagram showing a relation between a temperature [° C.] and a resistance [Ω] in a heat generator and the like of the heat generation unit according to embodiment 13.

FIG. 26 is a graph showing rising characteristics of the heat generation unit used in the image fixing apparatus according to the present invention, and a carbon heater and a halogen heater which are conventional heaters.

FIGS. 27(a) to 27(c) are views comparing a rush current in various heaters, where FIG. 27(a) shows a current waveform at a rising time of the heat generation unit 10 used in the image fixing apparatus according to the present invention, FIG. 27(b) shows a current waveform at a rising time of the conventional carbon heater, and FIG. 27(c) shows a current waveform at a rising time of the halogen heater.

FIG. 28 is a graph showing a result of measurement of a copper plate temperature at the time of heating an object to be heated by the heat generation unit used in the image fixing apparatus according to the present invention, and the conventional heater.

### BEST MODE FOR CARRYING OUT THE INVENTION

A description will be given in detail below of a preferred embodiment of a heat generation unit according to the present invention with reference to the accompanying drawings.

The inventors of the present invention have worked on developing a heat generation unit serving as a new heat source for various apparatuses by applying to a heat generator a new film sheet-shaped material (a film sheet raw material), which is completely different in a material and a manufacturing method from the heat generator used in a conventional heat generation unit, as a heat generating material. The film sheet-shaped material (the film sheet raw material) which is to be applied to the heat generator used in the heat generation unit as the new heat source has high efficiency and comes to a high temperature as mentioned below, and further has a small heat capacity because of its light and thin structure, and has an excellent rising characteristic.

### Embodiment 1

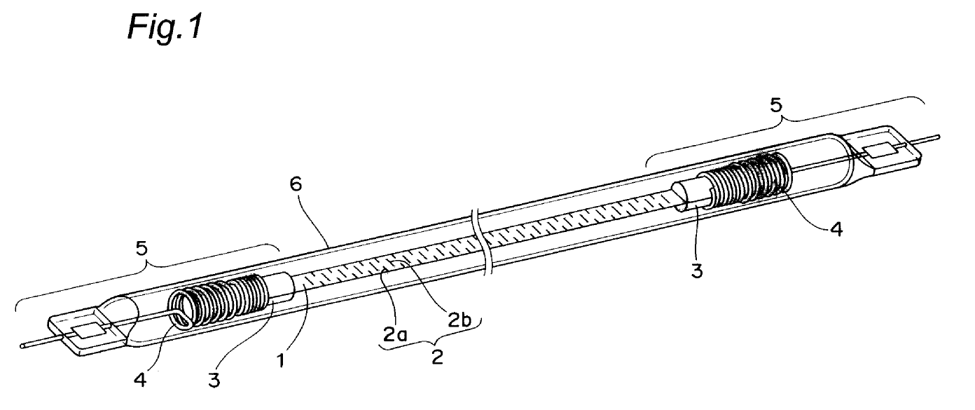

A description will be given below of a heat generation unit according to embodiment 1 of the present invention with reference to FIGS. 1 to 9. In the heat generation unit according to embodiment 1, a heat generator is constructed by a film sheet raw material in which a plurality of layers formed by using a carbon-based substance as a main component are laminated via an interval. In other words, in the film sheet raw material, a plurality of layers are laminated in a thickness direction of the layers while forming an interval with each other, and flexibility is provided. The film sheet raw material is formed in an elongated band shape having opposed band surfaces as front and rear sides thereof. Further, a current suppressing portion that is current suppressing means suppressing a current flowing in a longitudinal direction is formed in the band-like heat generator.

FIG. 1 is a perspective view showing the heat generation unit according to embodiment 1. A heat generator 1 (that is, an elongated sheet-like heat generator 1) of a film sheet raw material formed in an elongated band shape and having flexibility is arranged within an internal space formed by a tubular container 6 formed by a quartz glass or the like having a heat resistance. The structure is made such that a longitudinal direction of the heat generator 1 and a longitudinal direction of the container 6 come into line with each other. A holder 3 holding both end portions of the heat generator 1 by pinching or the like and having a circular column shaped cross section is arranged in each of the both end portions. A shape of the holder 3 may be formed in a polygonal shape in a cross section.

The holder 3 according to embodiment 1 is divided into two sections along a thrust axis thereof (a center axis in the longitudinal direction). An end portion of the heat generator 1 is pinched by two divided surfaces formed by dividing into two, and the heat generator 1 is held. The structure may be made such that engaging means such as a projection or the like is provided in the opposed divided surface, and the engaging means is engaged with engaging means such as a hole or the like formed in an end portion of the heat generator 1.

The holder 3 is held by a coil shape portion 4 formed in one end side of a power supply portion 5 and having a spring characteristic. The holder 3 is arranged in an inner side of the coil shape portion 4, is wound by the coil shape portion 4, and is held by the coil shape portion 4. The holder 3 and the power supply portion 5 are electrically connected by holding while the coil shape portion 4 applying to the holder 3 a pressure in a direction which is orthogonal to the thrust axis of the holder 3. An end portion of the heat generator 1 pinched by the opposed divided surfaces of the holder 3 is held at a desired position within the container 6. In the heat generator 1 held by the holder 3 as mentioned above, a tensile force is always applied to the longitudinal direction of the heat generator 1.

A method of holding the end portion of the heat generator 1 by the holder 3 according to embodiment 1 is not limited to the structure mentioned above, but may employ any structure as long as the end portion of the heat generator 1 can be securely held by the holder 3. For example, the structure may be made such that a hole is provided in the end portion of the heat generator 1, and a locking projection provided in the holder 3 is engaged with the hole, whereby the end portion of the heat generator 1 is locked so as to be held by the holder 3. Alternatively, the structure may be made such that the heat generator 1 is held by the holder 3 by filling an adhesive agent to a gap between the end portion of the heat generator 1 and the holder 3.

In embodiment 1, the electric connection between the holder 3 and the power supply portion 5 is achieved by winding a part of the coil shape portion 4 having the spring characteristic around the holder 3, however, the present invention is not limited to this structure. The connecting method between the holder 3 and the power supply portion 5 may employ any structure as long as the power can be directly or indirectly supplied to the heat generator 1, and any structure having the same effect is included in the present invention.

Further, in the coil shape portion 4 formed in a part of the power supply portion 5, a portion around which the holder 3 is not wound is not necessarily arranged in the both end portions of the heat generator 1 in some conditions such as a structure, a used state, an arranged state and the like of the heat generation unit, but may be provided in any one end portion of the heat generator 1.

Further, in the coil shape portion 4 formed in a part of the power supply portion 5, a portion which does not engage with the holder 3 is not necessarily conformed to the shape of the holder 3. For example, the coil shape portion 4 has such an effect that can regulate a position of the heat generator 1 by being set to a diameter which is adjacent to an inner diameter of the container 6. In this case, in the structure of the heat generation unit, there is a case where the position regulation with respect to the heat generator 1 by the coil shape portion 4 is not necessary. For example, in the structure in which the heat generator 1 and the container 6 do not come into contact with each other, the position regulating means of the heat generator 1 is not necessarily provided.

As shown in FIG. 1, a part of the power supply portion 5 having the heat generator 1, the holder 3 and the coil shape portion 4 is arranged in an internal space of the container 6. The container 6 is deposited at an intermediate position of the power supply portion 5, and the internal space of the container 6 is sealed. Each of end portions of the power supply portion 5 respectively derived outward from both ends of the container 6 is utilized as a terminal for supplying an external power to the heat generator 1. Air is removed in the internal space of the sealed container 6, and an inert gas such as an argon gas, a nitrogen gas or a mixed gas of the argon gas and the nitrogen gas is charged therein in place thereof.

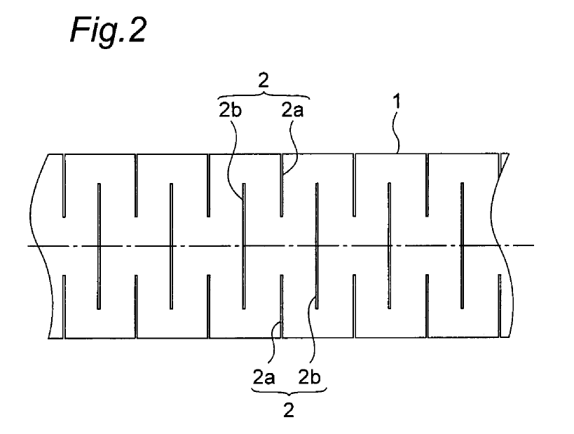

FIG. 2 is a plan view showing an example of an arrangement pattern of a current suppressing portion of the heat generator 1 in the heat generation unit according to embodiment 1.

As shown in FIG. 2, a plurality of current suppressing portions 2 (refer to FIG. 2) are provided in the heat generator 1 so as to extend in a band width direction (a vertical direction in FIG. 2), that is, a direction which is orthogonal to a longitudinal direction of the heat generator 1 and is in parallel to a band surface of the heat generator 1. The current suppressing portion 2 is formed by a cut line formed by pressing a cutting tool.

As shown in FIG. 2, the current suppressing portion 2 in the heat generator according to embodiment 1 has a first current suppressing portion 2a and a second current suppressing portion 2b. The first current suppressing portion 2a is provided so as to be extended linearly from each of opposed edges in the band width direction of the heat generator 1 toward a center portion in the band width direction of the heat generator 1. Further, a pair of first current suppressing portions 2a provided so as to be opposed are arranged on the same line which is orthogonal to the longitudinal direction of the heat generator 1. The second current suppressing portion 2b is formed in a center portion in the band width direction of the heat generator 1, and is provided so as to be extended linearly from the center portion of the heat generator 1 toward both side edges. The first current suppressing portion 2a and the second current suppressing portion 2b are arranged alternately while having a predetermined distance along the longitudinal direction of the heat generator 1. As mentioned above, since there are alternately provided the pair of first current suppressing portions 2a formed so as to be opposed from the both edges of the heat generator 1, and the second current suppressing portion 2b formed in the center portion of the heat generator 1, it is possible to obtain a desired stable resistance value in the surface of the heat generator 1 having a limited area, and it is possible to provide a heat generation unit having a higher wattage.

Next, a description will be given of a detail of the heat generator 1 used in embodiment 1 according to the present invention. The heat generator 1 is constructed by a film sheet raw material. The film sheet raw material is formed by laminating a plurality of layers via an interval. The film sheet raw material has flexibility, and is formed by using a carbon-based substance as a main component. In a cross sectional surface of the film sheet raw material, each of the layer surfaces is constructed by a linear portion, or a rounded portion such as a wavy portion or the like. In the film sheet raw material, an interval is formed between the opposed layer surfaces, and a plurality of layers are laminated in an overlapping state. An image of a formed state of the interval formed between the layer surfaces of the laminated layers in the film sheet raw material is similar to a cross sectional shape of a pie obtained by preparing a pie sheet by being folded at a plurality of times (for example, some tens or some hundreds) so as to overlap and baking the pie sheet. In other words, in a cross section obtained by cutting the film sheet raw material in a thickness direction, the layer surfaces of the adjacent layers are irregularly bonded, and the interval is formed in the portion which is not bonded.

The heat generator 1 of the film sheet raw material constructed as mentioned above shows such an excellent characteristic as a two-dimensional isotropic thermal conductivity that is such a characteristic that the heat conduction becomes equal in any place, in the surface direction of the layer surface. It is desirable that a coefficient of thermal conductivity which is necessary at least for the heat generator 1 according to embodiment 1 has a value equal to or more than 200 W/m·K. The heat generator 1 having a high coefficient of thermal conductivity equal to or more than 400 W/m·K is preferable. Further, with respect to the coefficient of thermal conductivity of the film sheet raw material, it is preferable that a ratio (hereinafter, referred to as a specific electric conductivity comparative value) of a specific electric conductivity in a direction (a layer thickness direction) which is orthogonal to the layer surface with respect to a specific electric conductivity in a direction (a layer surface direction) along the layer surface becomes equal to or less than one tenth.

The high polymer film used as the film sheet raw material constructing the heat generator 1 in the heat generation unit of embodiment 1 may include at least one kind of high polymer film selected from the group consisting of polyoxadiazole, polybenzothiazole, polybenzobisthiazole, polybenzooxazole, polybenzobisoxazole, polypyromellitic imide (pyromellitic imide), polyphenylene isophthalic amide (phenylene isophthalic amide), polyphenylene benzoimidazole (phenylene benzoimidazole), polyphenylene benzobisimidazole (phenylene benzobisimidazole), polythiazole and polyparaphenylenevinylene. Further, the filler to be added to the high polymer film include: phosphoric acid ester-based, calcium phosphate-based, polester-based, epoxy-based, stearic acid-based, trimellitic acid-based, metal oxide-based, organic tin-based, lead-based, azo-based, nitroso-based and solfonylhydrazide-based compounds. More specifically, examples of phosphoric acid ester-based compounds include: tricresyl phosphate, (trisisopropylphenyl) phosphate, tributyl phosphate, triethyl phosphate, trisdichloropropyl phosphate and trisbutoxyethyl phosphate. Examples of calcium phosphate-based compounds include: calcium dihydrogen phosphate, calcium hydrogen phosphorous and calcium triphosphate. Examples of polyester-based compounds include: adipic acid, azelaic acid, sebacic acid, phthalic acid, polymers obtained by a reaction with glycols, glycerins, and the like. Further, examples of stearic acid-based compounds include: dioctyl sebacate, dibutyl sebacate, and acetyltributyl citrate. Examples of metal oxide-based compounds include: calcium oxide, magnesium oxide and lead oxide. Examples of trimellitic acid-based compounds include: dibutyl fumarate and diethyl phthalate. Examples of lead-based compounds include: lead stearate and lead silicate. Examples of azo-based compounds include: azodicarboxylic amide and azobisisobutylonitrile. Examples of nitroso-based compounds include: nitrosopentamethylene tetramine. Examples of solfonylhydrazide-based compounds include: p-toluenesulfonyl hydrazide.

The film sheet-like heat generator is manufactured by laminating the film sheet raw material, processing at 2400° C. or higher under the inert gas and regulating the pressure of the gas treatment atmosphere generated in the process of forming graphite so as to control. Further, as necessary, it is possible to obtain a higher quality film sheet-like heat generator by rolling the film sheet-like heat generator manufactured as mentioned above. The film sheet-like heat generator manufactured as mentioned above is used as the heat generator 1 in the heat generation unit according to the present invention.

An adding amount of the filler is preferably in a range between 0.2 and 20.0% by weight, and is more preferably in a range between 1.0 and 10.0% by weight. An optimum adding amount varies in accordance with the thickness of the high polymer. In the case where the thickness of the high polymer is thin, the more adding amount is better, and in the case where the thickness of the high polymer is thick, the adding amount can be made less. A role of the filler exists in setting the heat treated film to a uniformly foamed state. In other words, the added filler generates the gas during heating, and is structured such that a cavity after the gas generation becomes a path so as to assist gentle passage of the cracked gas from the inner portion of the film. The filler serves for creating the uniform foamed state.

The film sheet raw material manufactured as mentioned above is worked into a desired shape by a trimming die such as a Thomson die and a Pinnacle die, a sharp-edged tool such as a rotary die cutter or the like, or a laser processing or the like.

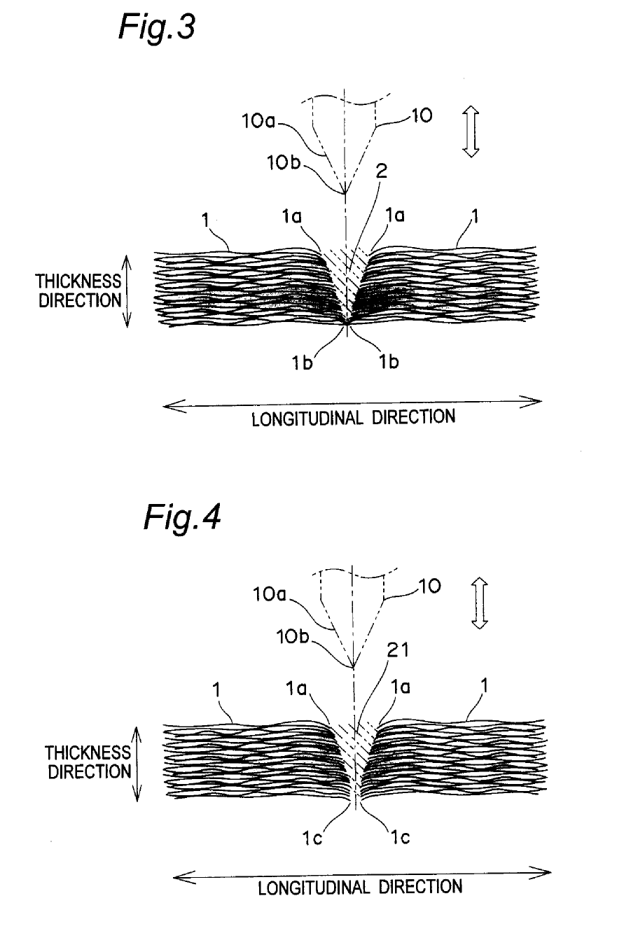

Next, a description will be given of the current suppressing portion 2 formed in the heat generator 1 with reference to FIG. 3. FIG. 3 is a cross sectional view showing a shear cross sectional shape of the heat generator 1 in which the current suppressing portion 2 is formed by the cutting tool. It is possible to more effectively form the current suppressing portion 2 in the heat generator 1 that is the feature of the present invention, by using a graphite film sheet raw material as the heat generator 1.

FIG. 3 is a cross sectional view showing a state where a pressing force is applied to the band-like heat generator 1 by a V-shaped metal cutting tool 10 in which a leading end portion 10b is sharp. In FIG. 3, the cutting tool 10 is shown by a two-dot chain line, and there is shown a state after the cutting tool 10 presses the heat generator 1. As shown in FIG. 3, the cutting tool 10 presses the heat generator 1 in a direction (a thickness direction of the heat generator 1) which is orthogonal to the longitudinal direction of the heat generator 1, and the pressing force is applied to one band surface (hereinafter, referred to as an upper band surface) of the heat generator 1 from a position above the heat generator 1 in FIG. 3 toward the other band surface (hereinafter, referred to as a lower band surface) of the heat generator 1 which is opposed to the upper band surface. FIG. 3 shows a state where the cutting tool 10 is returned to an upper initial position by suspending the shearing of the cutting tool 10 just after shearing a part of the heat generator 1 by the cutting tool 10, with respect to each of the laminated layers formed in the heat generator 1.

As shown in FIG. 3, the cutting tool 10 is pressed against the heat generator 1, whereby the sheared portion as a groove space is formed, and the sheared portion serves as the current suppressing portion 2 of the heat generator 1. At this time, a layer or a plurality of layers exist in a portion near a lower band surface that is positioned below the current suppressing portion 2 of the heat generator 1. The layer or the plurality of layers are sheared by the leading end portion 10b by pressing the cutting tool 10, however, approximately return to a position before being sheared by a repulsion force of the layers, and a simulated contact portion 1b is formed in a lower side of the sheared portion in the heat generator 1. The simulated contact portion 1b is crushed by a side wall surface inclined portion 10a of the cutting tool 10 after being sheared by the leading end portion 10b of the cutting tool 10, and comes to such a shape as to be folded to a downward side that is the pressing direction along the side wall surface inclined portion 10a of the cutting tool 10. However, the simulated contact portion 1b returns to some extent to the original position by an elastic force thereof, and cut end portions of the adjacent simulated contact portion 1b are arranged so as to be approximately opposed. The opposed cut end surfaces of the adjacent simulated contact portions 1b basically shut off a current flow and come to a state where they do not come into contact. However, since there is provided such a characteristic that the specific electric conductivity comparative value of the film sheet raw material is equal to or less than one tenth, even in a state where the opposed cut end surfaces of the adjacent simulated contact portions 1b electrically come into contact, the current flowing in the thickness direction of the heat generator 1 is small, and a current inflow in a direction in which the pressing is applied in the heat generator 1, that is, from the upper layer to the simulated contact portion 1b is hardly generated. As a result, such local heat generation that the current concentrates on the simulated contact portion 1b is prevented.

In the current suppressing portion 2, an opening portion peripheral edge portion 1a existing above the simulated contact portion 1b is structured such that opposed surfaces come away from each other by pressing the cutting tool 10 and a space is formed. Accordingly, the current flow is completely shut off in this portion. A side wall surface of the current suppressing portion 2 forming this space, that is, a cut end portion from an upper layer of the opening portion peripheral edge portion 1a of the heat generator 1 starting the shearing by the cutting tool 10 to a lower layer that is a portion near the simulated contact portion 1b is crushed by the side wall surface inclined portion 10a of the cutting tool 10 after being sheared by the leading end portion 10b of the cutting tool 10, in the same manner as the cut end surface of the simulated contact portion 1b, and comes to such a shape as to be folded downward along the side wall surface inclined portion 10a of the cutting tool 10. Particularly, the cut end portion near the opening portion peripheral edge portion 1a becomes a largely folded shape, and a large space is formed between the opposed surfaces of the opening portion peripheral edge portion 1a. As a result, in the heat generator 1, the current flow is shut off or suppressed securely by the space of the current suppressing portion 2. Accordingly, in the heat generator 1, it is easy to control the current flowing in the heat generator 1 by shearing with the pressing of the cutting tool 10 and forming the current suppressing portion 2.

Next, a description will be given of the other shape relating to the current suppressing portion of the heat generator 1 in the heat generation unit according to embodiment 1 of the present invention. FIG. 4 is a cross sectional view showing a current suppressing portion 21 having a different shape from the shear cross sectional shape of the current suppressing portion 2 shown in FIG. 3. FIG. 4 shows a state where the cutting tool 10 is moved upward after pressing the heat generator 1 from an upper band surface to a lower band surface, that is, from an upper side to a lower side, by using the cutting tool 10 so as to shear the heat generator 1.

In the current suppressing portion 21 shown in FIG. 4, a point different from the current suppressing portion 2 shown in FIG. 3 is that the current suppressing portion 21 is formed by being sheared completely by the cutting tool 10, and the cut end surfaces of a non-contact portion 1c existing in a lower side of the current suppressing portion 21 are opposed while having a space. Accordingly, the opposed non-contact portions 1c are in a state where they do not electrically come into contact with each other completely.

The heat generator 1 in a state shown in FIG. 4 is completely cut in a direction which is orthogonal to the layer surface direction by the cutting tool 10. Even in the non-contact portion 1c near the lower band surface of the heat generator 1, they are opposed electrically via a space. Accordingly, the heat generator 1 shown in FIG. 4 comes to an electrically non-contact state in all the layer surface directions of the heat generator 1 by the current suppressing portion 21, and the current is securely shut off by the current suppressing portion 21 in the heat generator 1. Accordingly, the current suppressing portion 21 shown in FIG. 4 can securely suppress the current flow and more accurately control the current, in comparison with the current suppressing portion 2 shown in FIG. 3.

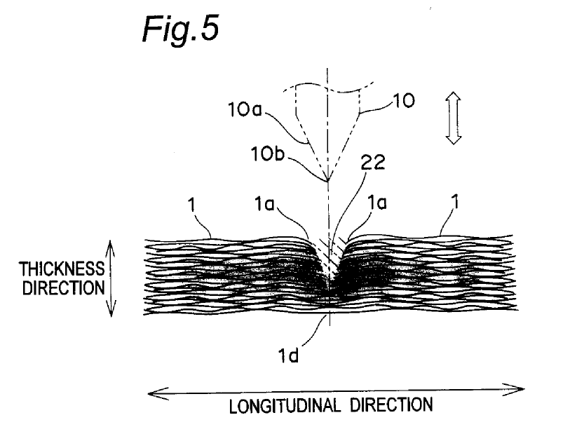

Next, a description will be given of further another shape relating to the current suppressing portion of the heat generator 1 in the heat generation unit according to embodiment 1 of the present invention. FIG. 5 is a cross sectional view showing a current suppressing portion 22 having further a different shape from the shear cross sectional shapes in the current suppressing portion 2 shown in FIG. 3 and the current suppressing portion 21 shown in FIG. 4. In the current suppressing portion 22 shown in FIG. 5, a point different from the current suppressing portion 2 shown in FIG. 3 is that an actually connected contact portion 1d is provided in place of the simulated contact portion 1b formed near the lower band surface of the heat generator 1. The contact portion 1d is formed by shearing a part of the heat generator 1 by the cutting tool 10, and setting the portion which is not sheared to the contact portion 1d. Accordingly, in the current suppressing portion 22 shown in FIG. 5, there is formed such a state that the lower position thereof is electrically connected as the contact portion 1d. In other words, in the heat generator 1 shown in FIG. 5, the current suppressing portion 22 shutting off the current flow is formed in the upper portion that is the upper band surface side, and the contact portion 1d in which the current flows is formed in the lower portion that is the lower band surface side.

As shown in FIG. 5, a side wall surface of the current suppressing portion 22, that is, a cut end portion as a cut surface from a layer of the opening portion peripheral edge portion 1a of the heat generator 1 starting the shearing by the cutting tool 10 to a layer near the contact portion 1d is crushed by the side wall surface inclined portion 10a of the cutting tool 10 after being sheared by the leading end portion 10b of the cutting tool 10 in the same manner as the side wall surface of the current suppressing portion 2 in FIG. 3, and is formed in such a shape as to be folded downward along the side wall surface inclined portion 10a of the cutting tool 10. Particularly, the cut end portion near the opening portion peripheral edge portion 1a is formed in such a shape as to be folded largely, and a great space is formed between the opposed surfaces. As a result, in the heat generator 1, the current flow is securely shut off by the space of the current suppressing portion 22. Further, in the current suppressing portion 22 shown in FIG. 5, since it is possible to regulate the value of the current flowing in the layer surface direction of the heat generator 1 by regulating the thickness of the contact portion 1d, it becomes further easy to control the current.

The description is given of the various shear cross sectional shapes of the current suppressing portions 2, 21 and 22 in the heat generator 1 with reference to FIGS. 3, 4 and 5, however, in order to make possible to have the current suppressing portion in any cases, the heat generator according to the present invention employs as the material the film sheet raw material having the layer having the carbon-based substance as the main component, and having the flexibility while a plurality of layers being laminated via the interval in the thickness direction of the layer. The heat generator 1 according to the present invention is preferably formed by using a material having an excellent two-dimensional isotropic thermal conductivity in the layer surface direction.

Since the heat generator in the heat generation unit according to the present invention is formed by the material mentioned above, the heat generator has the excellent two-dimensional isotropic thermal conductivity in the layer surface direction even if the heat generation temperature becomes partly higher, in the simulated contact portion 1b shown in FIG. 4, the non-contact portion 1c shown in FIG. 4 or the contact portion 1d shown in FIG. 5. Therefore, a heat quantity is dispersed in the layer surface direction and a local heat generation is prevented.

Further, in order to enhance quality of the heat generator, or in order to derive a characteristic corresponding to an intended use, the current suppressing portion of the heat generator according to the present invention may be formed by selectively using any shear cross sectional shape shown in FIGS. 3, 4 and 5. Further, the current suppressing portion of the heat generator according to the present invention may be formed by combining the shear cross sectional shapes shown in FIG. 3, FIG. 4 and/or FIG. 5. For example, the shear cross sectional shape shown in FIG. 3 is selected in a portion in which a resistance value of the heat generator is desired to be large, and the shear cross sectional shape shown in FIG. 4 is selected in a portion in which the resistance value is desired to be further larger. On the contrary, the shear cross sectional shape shown in FIG. 5 is selected in a portion in which the resistance value of the heat generator is desired to be small. Since it is possible to form an optional heat generation distribution in the heat generator by selecting a desired shear cross sectional shape as mentioned above, the heat generation unit according to the present invention using the heat generator can be employed in various intended uses.

A description will be given below of one example of a method of shearing the current suppressing portion of the heat generator according to the present invention. For example, there is employed a die having a sharp cutting tool portion such as a Thomson die, a Pinnacle die, a rotary die cutter or the like. The die previously forms a cutting tool portion having predetermined pattern and dimension. It is possible to easily form a heat generator having a desired shear pattern by pressing the die in the thickness direction of the heat generator and using cutting means for shearing the heat generator. The shear cross section states of the current suppressing portions 2, 21 and 22 shown in FIGS. 3, 4 and 5 mentioned above can be set to a desired shear cross sectional shape by controlling a distance for which the cutting tool 10 is movable in the cutting means, changing a height of the cutting tool 10 from a base, or optionally selecting an angle of a leading end of the cutting tool 10. Further, even in the case where the shear cross sectional shape is partly changed, it can be achieved by optionally changing the height of the cutting tool 10 from the base, or optionally selecting the angle of the leading end of the cutting tool 10.

There is a risk that the heat generator is damaged in some thickness or shear pattern of the heat generator, at the time of shearing the heat generator. Accordingly, it is preferable to arrange a holding sheet in a lower side of the heat generator at the time of shearing, by taking into consideration workability and a handling characteristic at the time of shearing. Further, in order to prevent a finishing precision from being deteriorated by a foreign material mixing at the time of shearing, it is preferable to shear in a state where an upper side of the heat generator is covered by a cover sheet. In other words, in the case where the holding sheet or the cover sheet is used, it is possible to precisely shear the heat generator by precisely controlling the height of the cutting tool at the time of shearing. For example, it is possible to carry out a half cut which is shearing the heat generator to a partway in the thickness direction at a high precision. Further, it is possible to employ a working method of shearing at least one of the holding sheet and the cover sheet together with the heat generator by regulating the height of the cutting tool at the time of shearing.

The description is given of the example using the sharp cutting tool as one example of the method of shearing the current suppressing portion of the heat generator according to the present invention, however, it is not always necessary to use the sharp cutting tool in the shearing method, but it is possible to shear by pressurizing by means of press working, roller working or the like, as long as the same effect as mentioned above can be obtained.

As the shearing means for forming the current suppressing portion of the heat generator according to the present invention, there can be considered working means such as laser working, press working or the like. In the press working, there are punching means in which a punching scrap is generated, and cutting means in which the punching scrap is not generated, described in embodiment 1. Accordingly, in the case where it is necessary to select a point that the whole heat generator can be effectively utilized since the punching scrap is not generated at all, it is preferable to select the cutting means described in embodiment 1.

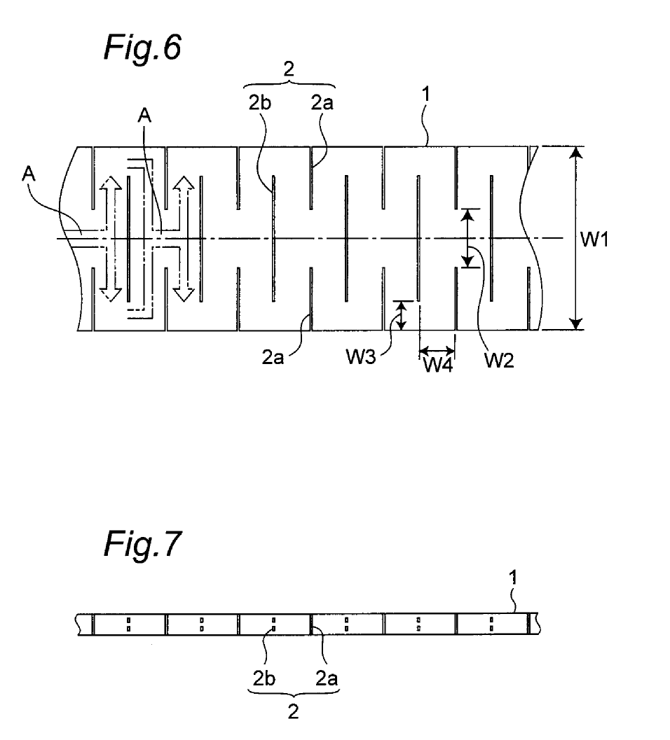

Next, a description will be given of a specific shearing pattern of the current suppressing portion formed in the heat generator 1 in the heat generation unit according to embodiment 1 of the present invention with reference to FIGS. 6 to 9.

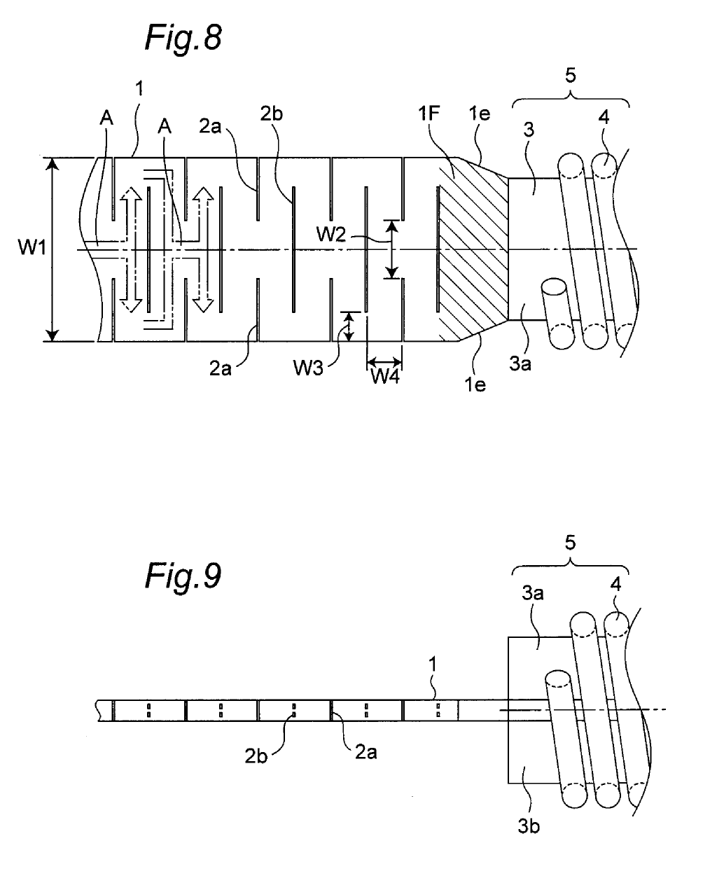

FIG. 6 is a plan view showing a shear pattern of the current suppressing portion of the heat generator 1 in the heat generation unit according to embodiment 1. FIG. 7 is a front view of the heat generator 1 in FIG. 6. FIG. 8 shows an end portion of the heat generator 1 shown in FIG. 6, and is a plan view showing a state where the end portion of the heat generator 1 is held by the holder 3. FIG. 9 is a front view of the end portion of the heat generator 1 in FIG. 8.

In the heat generator 1 shown in FIG. 6, in order to inhibit the current from flowing linearly from a left side toward a right side, two kinds of current suppressing portions 2 (the first current suppressing portion 1a and the second current suppressing portion 2b) are formed so as to be in parallel to the band width direction of the heat generator 1 having a band width W1, that is, orthogonal to the longitudinal direction of the heat generator 1. Accordingly, in the heat generator 1, a current A flows in a direction of an arrow shown by a meandering two-dot chain line in FIG. 6.

The first current suppressing portions 2a that is one of the current suppressing portions 2 are provided so as to be extended respectively linearly from both opposed side edges in the band width direction of the heat generator 1 toward the center portion of the heat generator 1. The pair of first current suppressing portions 2a respectively extended from the both side edges of the heat generator 1 toward the center portion are arranged on the same line which is orthogonal to the longitudinal direction. The respective opposed end portions of the pair of first current suppressing portions 2a are arranged so as to have a predetermined distance W2. Accordingly, the respective opposed end portions of the pair of opposed first current suppressing portions 2a are arranged at a predetermined distance W2. A center portion of the heat generator 1 having the predetermined distance W2 between the pair of first current suppressing portions 2a and 2a becomes a center side conduction path. The pair of first current suppressing portions 2a and 2a formed as mentioned above are formed so as to be spaced at a uniform distance while having a predetermined distance in the longitudinal direction of the heat generator 1.

The second current suppressing portion 2b that is the other current suppressing portion 2 is formed in the center portion in the band width direction of the heat generator 1, and is formed between the first current suppressing portion 2a and the first current suppressing portion 2a formed at the predetermined distance, in the longitudinal direction of the heat generator 1. In embodiment 1, the second current suppressing portion 2b is formed in an intermediate position of the first current suppressing portion 2a formed along the longitudinal direction of the heat generator 1, and is formed in parallel to the first current suppressing portion 2a while having a distance W4 from the first current suppressing portion 2a in the longitudinal direction of the heat generator 1. In the center portion in the band width direction of the heat generator 1, the second current suppressing portion 2b which is in parallel to the first current suppressing portion 2a is arranged in such a manner that both end portions thereof have a predetermined distance W3 from the both side edges of the heat generator 1. The predetermined distance W3 from the both end portions of the second current suppressing portion 2b to the both side edges of the heat generator 1 is set to one half of the predetermined distance W2 between the pair of first current suppressing portions 2a and 2a. The both side portions having the predetermined distance W3 of the second current suppressing portion 2b in the heat generator 1 become an edge side conduction path.

As mentioned above, in the heat generator 1 according to embodiment 1, the first current suppressing portion 2a and the second current suppressing portion 2b are arranged alternately while having a predetermined distance along the longitudinal direction of the heat generator 1, and the distance W4 has the same dimension as the width W3 of the edge side conduction path. Embodiment 1 is formed in such a manner that dispersion of the heat generation quantity in the conduction path of the heat generator 1 becomes small. In FIGS. 6 and 7, the shapes of the first current suppressing portion 2a and the second current suppressing portion 2b are illustrated as “notch portion” having a gap in view of the drawing, however, an actual shape is constructed by any shear cross sectional shapes shown in FIGS. 3, 4 and 5 mentioned above (the figures mentioned below will be illustrated in the same manner).

In the case where a predetermined voltage is applied to the both end portions of the heat generator 1 constructed as mentioned above, and a rated current A is applied to the heat generator 1, the current A flows in the center side conduction path having the width W2 formed between the pair of first current suppressing portions 2a, and a dispersed current A/2 flows in one of the edge side conduction paths having the width W3 and formed between the second current suppressing portion 2b and the both side edges. Accordingly, the current A in the heat generator 1 flows in a meandering manner. A resistance value as a whole of the heat generator 1 is decided based on a total length, a width and a thickness of the conduction path in which the current flows in a meandering manner, and can be easily and accurately calculated by each of the lengths W1, W2, W3, W9 and the like in the heat generator 1, which is decided by the first current suppressing portion 2a and the second current suppressing portion 2b. Further, since the heat generator 1 has a high thermal conductivity, the whole of the heat generator 1 reaches a uniform and stable temperature in a moment. It should be noted that a relationship between the lengths W2 and W3 in the heat generator 1 does not affect a uniform temperature distribution even if the length W3 is equal to or less than one half of the length W2, as long as the material has a characteristic that the coefficient of thermal conductivity in the surface direction is, for example, equal to or more than 600 W/m·K, depending on the coefficient of thermal conductivity of the heat generator 1. Accordingly, in the case of giving priority to achievement of the uniform temperature distribution, it is not always necessary that the length W3 is one half of the length W2. However, if the length W3 from the both end portions of the second current suppressing portion 2b to the both side edges comes to about 1 mm, there is a possibility that a crack is generated in the edge side conduction paths formed in both sides of the second current suppressing portion 2b, and there is further a risk that the heat generator is damaged. Accordingly, in the case of designing the shear pattern of the heat generator 1, it is necessary to pay attention to the shape of the second current suppressing portion 2b.

As shown in FIGS. 8 and 9, as is described in FIG. 1 mentioned above, the end portion of the heat generator 1 in the heat generation unit is provided with the holder 3 holding the end portion of the heat generator 1, and the power supply potion supplying the power to the heat generator 1. The holder 3 is electrically connected by the coil shape portion 4 in one end of the power supply portion 5, and the power is supplied to the heat generator 1 via the power supply portion 5 and the holder 3. The holder 3 is constructed by two holding bodies 3a and 3b divided into two sections in such a manner as to have a pinching surface pinching the end portion of the heat generator 1 and having a conductivity. In a state where the end portion of the heat generator 1 is inserted between the opposed pinching surfaces of the respective holding bodies 3a and 3b, the holding bodies 3a and 3b are crimped to each other while being wound in their peripheries by the coil shape portion 4 in one end of the power supply portion 5, and the end portion of the heat generator 1 is held.

In the heat generator 1 in the heat generation unit according to embodiment 1, a heat dissipation region 1F in which the first current suppressing portion 2a and the second current suppressing portion 2b are not formed, is provided in a region which is not held by the holder 3 near the end portion of the heat generator 1. In FIG. 8, the heat dissipation region 1F is shown by a diagonal line. Since the heat dissipation region 1F is provided near the end portion of the heat generator 1, the heat conducted from the heat generator 1 to the holder 3 and the power supply portion 5 is lowered. Accordingly, in the heat generator in the heat generation unit according to embodiment 1, a reduction of a thermal stress and a long service life are achieved.

Since the heat generator 1 in the heat generation unit according to embodiment 1 is formed in the sheet shape having the carbon-based substance as the main component, it is easy to be worked. Accordingly, in the case where the dimension in the width direction is different between the heat generator 1 and the holder 3, it is preferable to gradually narrow the width of the heat generator 1 so as to set to the same bonding width as the width of the holder 3, in the shape near the bonding portion between the heat generator 1 and the holder 3, as shown in FIG. 8. For example, as shown in FIG. 8, the shape near the bonding portion between the heat generator 1 and the holder 3 is constructed by a linearly inclined portion 1e, or a curved portion in a rounded manner. For example, it may be formed in a curved shape which is concaved to the center portion side in the band width direction of the heat generator 1, or a curved shape which protrudes to an opposite side thereto. It is possible to prevent a concentrated load from being applied to a portion near the bonded portion of the heat generator 1 by forming the portion near the bonding portion between the heat generator 1 and the holder 3. As a result, it is possible to prevent the heat generator 1 from being damaged, and it is possible to provide a heat generation unit having a long service life.

In embodiment 1, the description is given of the example in which the first current suppressing portion 2a and the second current suppressing portion 2b are formed as the current suppressing portion in the heat generator 1, however, in the case of using the heat generator having the two-dimensional isotropic thermal conductivity in the present invention, it is possible to construct an excellent heat source which has a high wattage and can achieve a reduction of the thermal stress and a long service life, by using various shear patterns as the current suppressing portion. For example, the current suppressing portion may be structured such as to arrange the first current suppressing portion 2a linearly extended from one edge of the both opposed side edges of the heat generator 1 toward the center line which is in parallel to the longitudinal direction of the heat generator, and the first current suppressing portion 2a extended from the other edge toward the center line alternately so as to have a predetermined distance along the longitudinal direction of the heat generator 1. In this case, the current suppressing portion is constructed only by the first current suppressing portion 2a.

### Embodiment 2

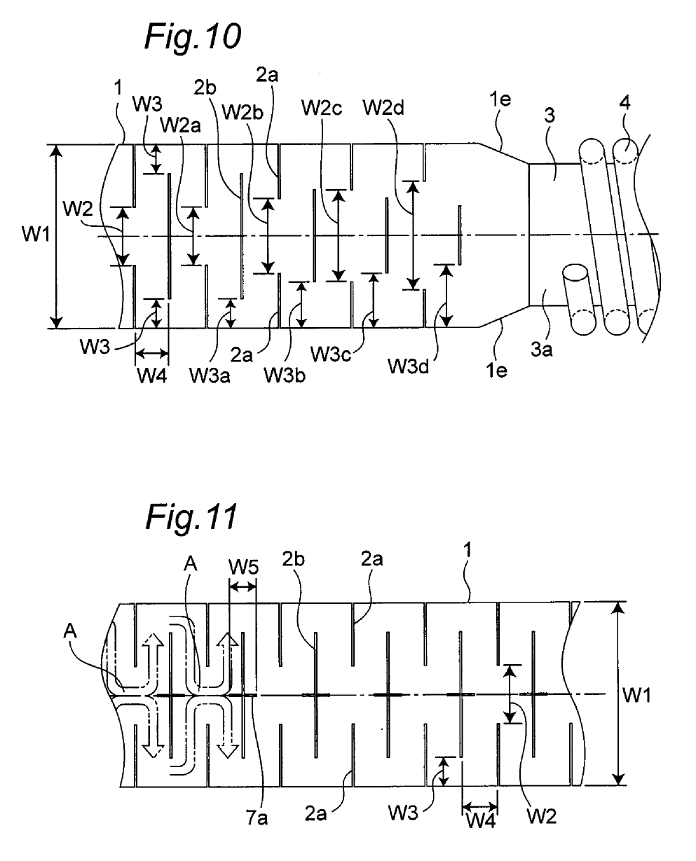

Next, a description will be given of a heat generation unit according to embodiment 2 of the present invention with reference to FIG. 10. In the heat generation unit according to embodiment 2, a point different from the heat generation unit according to embodiment 1 mentioned above is a shear pattern of the current suppressing portion in the heat generator. The other points in embodiment 2 are the same as the heat generation unit according to embodiment 1. Accordingly, in the heat generation unit according to embodiment 2 described below, a description will be given only of the different point by using the description of the heat generation unit according to embodiment 1 in the overlapping description. In the description of the heat generation unit according to embodiment 2, the same reference numerals are used for the elements having the same functions and structures as those of the elements in the heat generation unit according to embodiment 1.

FIG. 10 is a plan view showing the structure of the current suppressing portion of the heat generator 1 in the heat generation unit according to embodiment 2, and shows a portion near the end portion of the heat generator 1. A point different from the heat generator 1 according to embodiment 1 shown in FIG. 8 is that the shapes of the first current suppressing portion 2a and the second current suppressing portion 2b respectively have different dimensions and shapes according to their formed positions, in the region of the heat generator 1 close to the holding portion 3.

In the heat generator 1 according to embodiment 1 shown in FIG. 8 mentioned above, the width W2 of the center side conduction path formed between the opposed end portions of the pair of opposed first current suppressing portions 2a is constant. On the other hand, in the heat generator 1 in embodiment 2, the structure is made such as to become gradually wider in accordance with coming close to the holding portion 3, in the region in which the width W2 of the center side conduction path is close to the holding portion 3.

As shown in FIG. 10, in the heat generator 1 according to embodiment 2, the width W2 of the center side conduction path formed between the opposed end portions of the pair of opposed first current suppressing portions 2a formed in the center portion in the longitudinal direction is equal to the width W2 of the center side conduction path according to embodiment 1, and is formed narrow. However, in embodiment 2, the width W2 of the center side conduction path in the region close to the holding portion 3 is formed gradually wider in accordance with coming close to the holding portion 3. In FIG. 10, the width of the center side conduction path is expressed by W2a, W2b, W2c and W2d so as to indicate that it becomes gradually wider. In other words, in the region near the end portion of the heat generator 1 according to embodiment 2, the length from the both side edges of the heat generator 1 in the first current suppressing portion 2a is made gradually shorter in accordance with coming close to the holder 3, and the width of the center side conduction path is set to be gradually wider in such a manner as to satisfy a relationship W2a<W2b<W2c<W2d. Accordingly, the resistance value of the center side conduction path becomes gradually smaller in accordance with coming close to the holder 3 in the region near the end portion of the heat generator 1, and the heat conducted from the heat generator 1 to the holder 3 and the power supply portion 5 is greatly reduced. As a result, in the heat generator 1 in the heat generation unit according to embodiment 2, the reduction of the thermal stress and the long service life are achieved.

Further, in the heat generator 1 according to embodiment 2, since an area of the conduction path in the region near the holding portion becomes gradually wider, a stress generated at the time of the drop, the oscillation and the shock is dispersed, and a disconnection accident of the heat generator 1 is prevented, and the heat generator 1 is prevented from being twisted, so that the long service life of the heat generator 1 is achieved.

Further, as shown in FIG. 10, in the heat generator 1 according to embodiment 2, the width W3 of the edge side conduction paths formed in the both sides of the second current suppressing portion 2b formed in the center portion in the longitudinal direction thereof is equal to the width W2 of the edge side conduction path according to embodiment 1, and is formed narrower. However, in embodiment 2, the width W3 of the edge side conduction path in the region close to the holding portion 3 is formed gradually wider in accordance with coming close to the holding portion 3. In FIG. 10, the width of the edge side conduction path is expressed by W3a, W3b, W3c and W3d so as to indicate that it becomes gradually wider. In other words, in the region near the end portion of the heat generator 1 according to embodiment 2, the length of the second current suppressing portion 2b is made gradually shorter in accordance with coming close to the holder 3, and the width of the edge side conduction path is set to be gradually wider in such a manner as to satisfy a relationship W3a<W3b<W3c<W3d. Accordingly, the resistance value of the edge side conduction path becomes gradually smaller in accordance with coming close to the holder 3 in the region near the end portion of the heat generator 1, and the heat conducted from the heat generator 1 to the holder 3 and the power supply portion 5 is greatly reduced. As a result, in the heat generator 1 in the heat generation unit according to embodiment 2, the reduction of the thermal stress and the long service life are achieved.

Further, in the heat generator 1 according to embodiment 2, since the area of the conduction path in the region near the holding portion becomes gradually wider, a stress generated at the time of the drop, the oscillation and the shock is dispersed, and a disconnection accident of the heat generator 1 is prevented, and the heat generator 1 is prevented from being twisted, so that the long service life of the heat generator 1 is achieved.

It should be noted that the same effect is achieved by structuring such as to gradually widen any one of the width W2 of the center side conduction path and the width W3 of the edge side conduction path in accordance with coming close to the holder 3 in the region near the end portion of the heat generator 1, however, it becomes more preferable to gradually widen both of the widths together.

Further, although not illustrated, the structure may be made such as to form the width W2 in the center side conduction path formed between the opposed end portions of the first current suppressing portion 2a and the width W3 of the edge side conduction paths formed in the both sides of the second current suppressing portion 2b gradually wider in accordance with coming close to the holder 3, and it is possible to form the distance W4 between the first current suppressing portion 2a and the second current suppressing portion 2b in the longitudinal direction of the heat generator 1 gradually wider in accordance with coming close to the holder 3 in the same manner. The heat generator comes to have a uniform resistance value and temperature distribution by forming as mentioned above, and it is possible to construct the heat generation unit which is excellent in safety and reliability.

Further, in the region near the both end portions of the heat generator 1, it is not always necessary to set each of the distances between the respective portions of the center side conduction path portion formed by the first current suppressing portion 2a while having the widths W2a, W2b, W2c and W2d and the holder 3, and each of the distances between the respective portions of the edge side conduction path formed by the second current suppressing portion 2b while having the widths W3a, W3b, W3c and W3d and the holder 3 to the same dimension in the both end portions of the heat generator 1. For example, in the heating apparatus in which the heat generation unit is placed vertically, that is, in the heating apparatus arranged in such a manner that the longitudinal direction of the heat generator 1 is the vertical direction to the floor, since a temperature of a top surface of the heating apparatus becomes high, it is possible to lower the temperature rise of the deposited portion between the coil shape portion 4 of the power supply portion 5 and the container 6 by widening the distance between the first current suppressing portion 2a or the second current suppressing portion 2b positioned in the top surface side of the heating apparatus and the holder 3. As a result, it is possible to obtain a heating apparatus which is safe and has a long service life.

### Embodiment 3

Next, a description will be given of a heat generation unit according to embodiment 3 of the present invention with reference to FIG. 11. In the heat generation unit according to embodiment 3, a point different from the heat generation unit according to embodiment 1 mentioned above is a shear pattern of the current suppressing portion in the heat generator. The other points in embodiment 3 are the same as those of the heat generation unit according to embodiment 1. Accordingly, in the heat generation unit according to embodiment 3 described below, an overlapping description employs the description of the heat generation unit according to embodiment 1, and a description will be given only of the different point. In the description of the heat generation unit according to embodiment 3, the same reference numerals are used for the elements having the same functions and structures as the elements in the heat generation unit according to embodiment 1.

FIG. 11 is a plan view showing a structure of the current suppressing portion of the heat generator 1 in the heat generation unit according to embodiment 3, and shows a shear pattern of the current suppressing portion. A point different from the heat generator 1 according to embodiment 1 shown in FIG. 8 is that a third current suppressing portion 7a is provided in addition to the first current suppressing portion 2a and the second current suppressing portion 2b. The third current suppressing portion 7a is structured such as to guide a current in a width direction flowing along the second current suppressing portion 2b formed in the center portion of the heat generator 1 in a desired direction.

As shown in FIG. 11, the third current suppressing portion 7a is formed so as to be orthogonal to the second current suppressing portion 2b formed in the center portion of the heat generator 1. In the heat generator 1 in the heat generation unit according to embodiment 3, the third current suppressing portion 7a is formed on the center line in the longitudinal direction of the heat generator 1 that is the center in the band width direction of the heat generator 1. The third current suppressing portion 7a is structured such as to divide a current A (an arrow shown by a two-dot chain line in FIG. 11) flowing from the center side conduction path having the width W2 formed by the pair of first current suppressing portions 2a by the second current suppressing portion 2b so as to flow to the edge side conduction path having the width W3 formed in each of the both side edges of the heat generator 1. In other words, the third current suppressing portion 7a disperses the current A to each of the edge side conduction paths formed in the both sides of the heat generator 1 by a current A/2. As a result, in the heat generator 1 according to embodiment 3, the current A flowing from the center side conduction path having the width W2 and formed between the pair of first current suppressing portions 2a is equally divided into the conduction paths having the width W4 and formed between the first current suppressing portion 2a and the second current suppressing portion 2b, and the current A/2 is flown in each of the paths. Accordingly, a resistance value of the heat generator 1 becomes stable, and it is possible to achieve uniform temperature distribution (heat arrangement) and luminescence distribution (light arrangement). Therefore, it is possible to construct a heating apparatus in which safety is high and a service life is long, by using the heat generation unit according to embodiment 3 as a heat source.

In the heat generator 1 shown in FIG. 11, the description is given of the case where the third current suppressing portion 7a is formed in the center in the band width direction of the heat generator 1, however, the third current suppressing portion is not necessarily formed in the center in the band width direction of the heat generator 1. For example, in FIG. 11, the third current suppressing portion 7a may be formed in a downward direction or an upward direction from the center in the band width direction of the heat generator 1. In the case where the third current suppressing portion 7a is formed as mentioned above, the resistance value of the edge side conduction path having the width W3 and existing in the upper side of the heat generator 1 shown in FIG. 11 is different from the resistance value of the edge side conduction path having the width W3 and existing in the lower side. As a result, it is possible to change the temperature distributions of the edge side conduction path in the upper side and the edge side conduction path in the lower side, and it is possible to set the desired temperature distribution (heat arrangement) and luminescence distribution (light arrangement). As mentioned above, in accordance with the structure of embodiment 3, since it is possible to set the desired temperature distribution, it is possible to achieve the heat generation unit having a higher wattage.

In the heat generator 1 shown in FIG. 11, the description is given of the case where the width W5 of the third current suppressing portion 7a in the longitudinal direction of the heat generator 1 is approximately the same as the width W4 that is the distance between the first current suppressing portion 2a and the second current suppressing portion 2b, or the width W3 that is the distance from the end portion of the second current suppressing portion 2b to the edge of the heat generator 1. However, it is not always necessary that these widths W3, W4 and W5 are the same, and the widths are appropriately set in correspondence to an intended purpose of the heat generator 1 or the like. For example, it is possible to further stabilize the resistance value of the center side conduction path in the heat generator 1 so as to achieve a uniform heat arrangement in a whole of the heat generator, by making the width W5 longer than the width W4 or the width W3.

In the third current suppressing portion 7a mentioned above, the description is given of the regulation of the formed position in the band width direction of the heat generator 1, and the regulation of the width W5 in the longitudinal direction of the heat generator 1, separately, however, it goes without saying that each of the effects can be obtained by executing these regulations together.

In the heat generator 1 shown in FIG. 11, the description is given of the example in which the first current suppressing portion 2a, the second current suppressing portion 2b and the third current suppressing portion 7a are formed, however, the current suppressing portion may be constructed by a cross-shaped cut line by the second current suppressing portion 2b and the third current suppressing portion 7a without the first current suppressing portion 2a. In the heat generator 1 constructed as mentioned above, since the second current suppressing portion 2b and the third current suppressing portion 7a are formed at positions at which a strain is hard to be generated with respect to the heat generator 1, excellent stability is provided with respect to torsion and deformation of the heat generator 1, and it is possible to provide a heat generation unit in which a desired temperature distribution can be set by appropriately selecting the dimensions or the formed positions of the second current suppressing portion 2b and the third current suppressing portion 7a.

### Embodiment 4

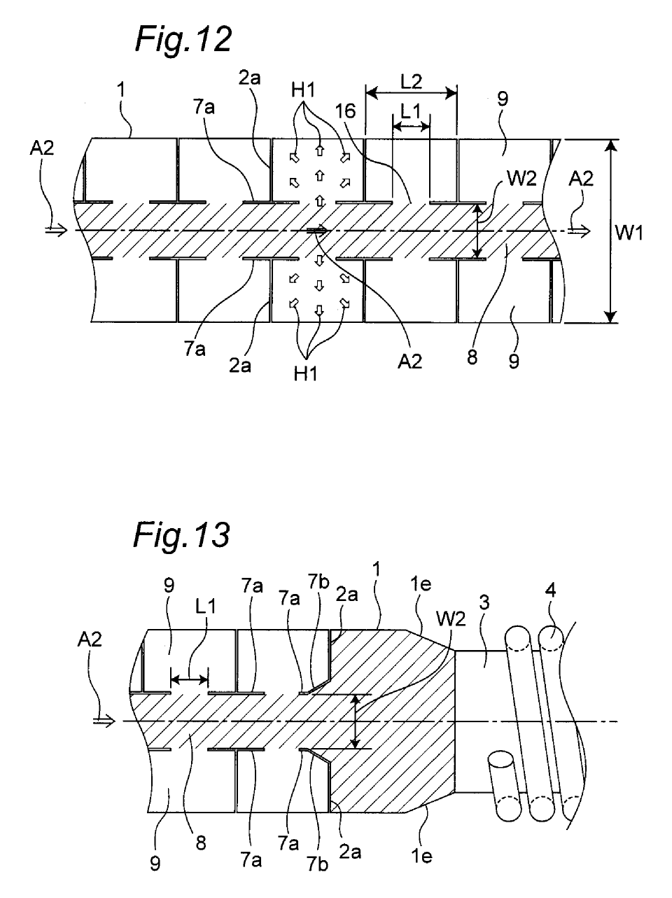

Next, a description will be given of a heat generation unit according to embodiment 4 of the present invention with reference to FIG. 12. In the heat generation unit according to embodiment 4, a point different from the heat generation unit according to embodiment 1 mentioned above is a shear pattern of the current suppressing portion in the heat generator. The other points in embodiment 4 are the same as those of the heat generation unit according to embodiment 1. Accordingly, in the heat generation unit according to embodiment 4 described below, an overlapping description employs the description of the heat generation unit according to embodiment 1, and a description will be given only of the different point. In the description of the heat generation unit according to embodiment 4, the same reference numerals are used for the elements having the same functions and structures as the elements in the heat generation unit according to embodiment 1.

FIG. 12 is a plan view showing a structure of the current suppressing portion of the heat generator 1 in the heat generation unit according to embodiment 4, and shows a shear pattern of the current suppressing portion. A point different from the heat generator 1 according to embodiment 1 shown in FIG. 8 is that the second current suppressing portion 2b extended in parallel to the band width direction of the heat generator 1 is not provided and a third current suppressing portion 7a extended in parallel to the longitudinal direction of the heat generator 1 is formed.

As shown in FIG. 12, the heat generator 1 having the band width W1 is provided with a first current suppressing portion 2a formed in parallel to the bandwidth direction, and a third current suppressing portion 7a formed in parallel to the longitudinal direction of the heat generator 1 while coming into contact with a center side end portion of the first current suppressing portion 2a. A pair of first current suppressing portions 2a are provided so as to be extended respectively linearly from the both opposed side edges of the heat generator 1 toward the center along the band width direction, and center side end portions of the pair of first current suppressing portions 2a are opposed while having a fixed distance. Plural sets of the pair of first current suppressing portions 2a are arranged so as to have a predetermined distance L2 along the longitudinal direction of the heat generator 1. Accordingly, in the heat generator 1 according to embodiment 4, the current flowing in the longitudinal direction in the both edge sides of the heat generator 1 is obstructed by the first current suppressing portions 2a provided in the both edge sides of the heat generator 1.

Further, a pair of third opposed current suppressing portions 7a extended in parallel to the longitudinal direction of the heat generator 1 are formed in the heat generator 1 according to embodiment 4 so as to be opposed in parallel, for suppressing the current flowing in the band width direction of the heat generator 1. The pair of third current suppressing portions 7a are formed so as to be in contact with the both opposed end portions of the pair of first current suppressing portions 2a, and the center side conduction path having the width W2 and flowing the current A2 therethrough is formed between the pair of third opposed current suppressing portions 7a. The center side conduction path becomes a current-carrying region 8 (a diagonal line portion in FIG. 12) having a width allowing predetermined heat generation.

In the heat generator 1 shown according to embodiment 4, the pair of third current suppressing portions 7a are formed in parallel, and are provided in such a manner as to be extended linearly in the longitudinal direction of the heat generator 1 while setting the same line (for example, a center axis which is in parallel to the longitudinal direction of the heat generator 1) to a symmetric axis. Further, the pair of third current suppressing portions 7a are formed in such a manner as to be coupled to the opposed end portions of the pair of first current suppressing portions 2a.

As mentioned above, in the heat generator 1 according to embodiment 4, a T-shaped current suppressing portion constructed by the first current suppressing portion 2a and the third current suppressing portion 7a is formed so as to be opposed to the both edge side portions of the heat generator 1. A plurality of the third current suppressing portions 7a formed along the longitudinal direction of the heat generator 1 form a current-carrying region 8 in the center portion along the longitudinal direction of the heat generator 1, and form a heat dissipation region 9 surrounded by the T-shaped current suppressing portion of the first current suppressing portion 1a and the third current suppressing portion 7a which are adjacent to each other near the both edge side portions of the heat generator 1. Further, the portion pinched by the adjacent third current suppressing portions 7a becomes a heat conduction port 16 having a distance L1. The heat conduction port 16 serves as an inlet for effectively conducting heat generated in the current-carrying region 8 of the heat generator 1 to the heat dissipation region 9.

In the heat generator 1 according to embodiment 4, the T-shaped current suppressing portions constructed by the first current suppressing portions 2a and the third current suppressing portions 7a are formed in two rows while having a fixed distance (a width W2) in the both sides of the heat generator 1 along the longitudinal direction of the heat generator 1. Further, the T-shaped current suppressing portions are arranged intermittently while having a fixed distance (a distance L2) along the longitudinal direction of the heat generator 1.

A shear cross sectional shape of the third current suppressing portion 7a and a forming method thereof are formed in the same manner as the first current suppressing portion 2a, as described with reference to FIGS. 3, 4 and 5.

In the case where a rated voltage is applied to the both ends of the heat generator 1 according to embodiment 4 constructed as mentioned above, the current A2 flows in the current-carrying region 8 formed in the center portion of the heat generator 1, and the current A2 does not flow in the heat dissipation region 9 surrounded by the first current suppressing portion 2a and the third current suppressing portion 7a near the both edge side portions of the heat generator 1. Accordingly, the heat is generated in the current-carrying region 8 upon energization, and the temperature thereof rises. On the other hand, the heat generated in the current-carrying region 8 is conducted to the heat dissipation region 9 through the heat conduction port 16 having the distance L1 formed between the adjacent second current suppressing portions 7a, as shown by an arrow H1 (refer to FIG. 12). As mentioned above, in embodiment 4, the heat generator 1 having a high wattage can be constructed by providing the current-carrying region 8 generating heat upon energization, and the heat dissipation region 9 to which the heat generated in the current-carrying region 8 is conducted and which radiates heat. Further, according to the heat generator 1 in embodiment 4, it is possible to form a heat source having a large heat generation area.

In FIG. 12, a direction in which the heat is conducted only in one heat dissipation region 9 is shown by an arrow, however, the heat is conducted in the same manner in the other heat dissipation regions, and the conducting direction thereof is not specified by the direction of the arrow shown in FIG. 12.

Further, a relationship between the arranged distance L2 of the first current suppressing portion 2a in the longitudinal direction of the heat generator 1 and the arranged distance L1 of the third current suppressing portion 7a in the longitudinal direction of the heat generator 1 varies in accordance with the material of the heat generator 1, however, it is preferable to generally set to a range L1/L2=0.2 to 0.9, and it is possible to obtain the desired current-carrying region 8 and heat dissipation region 9 in the heat generation unit according to the present invention within this range. In the case where L1/L2 is smaller than 0.2, it is impossible to sufficiently conduct the heat generated upon energization and an effective heat dissipation cannot be obtained. Further, a temperature difference is generated in a boundary portion between the current-carrying region 8 and the heat dissipation region 9, and there is generated a risk that the heat generator 1 ruptures.

On the contrary, in the case where L1/L2 is larger than 0.9, the current flows in the heat dissipation region 9, and a current greater than the current to actually flow only in the current-carrying region 8 flows, so that it becomes hard to predict the resistance value of a whole of the heat generator 1. Further, in the current-carrying region 8 existing between two rows of third current suppressing portions 7a opposed in the band width direction of the heat generator 1, the resistance value becomes locally small, and there is generated a risk that the heat generator 1 ruptures due to a thermal stress.

For example, a description will be given of a case where experiments are carried out by setting a surface temperature of the current-carrying region 8 of the heat generator 1 to 1100° C. while using the heat generator 1 having a thickness t=300 μm, a width W1=4.5 mm (a width of the current-carrying region 8=1.5 mm, a width of heat dissipation regions in both sides=1.5 mm), a length=300 mm, and a coefficient of thermal conductivity in a surface direction=600 W/mK.

First, in the experiment in the case of setting L1/L2=0.5, the minimum value of the surface temperature in the heat dissipation region 9 was 1060° C. which is lower than the surface temperature in the current-carrying region 8, and the temperature difference was 40° C. (3.6% with respect to 1100° C.). Next, in the experiment in the case of setting L1/L2=0.2, the minimum value of the surface temperature in the heat dissipation region 9 was 990° C. which is lower than the surface temperature in the current-carrying region 8, and the temperature difference was 110° C. (10.0% with respect to 1100° C.). It is preferable that a surface temperature dispersion of the heat generator 1 is within 10% as a product.

Next, in the case of setting L1/L2=0.9, the minimum value of the surface temperature in the heat dissipation region 9 was 1080° C. which is lower than the surface temperature in the current-carrying region 8, and the temperature difference was 20° C. (1.8% with respect to 1100° C.).

Based on the results of experiments mentioned above, in the heat generator according to the present invention, it is possible to obtain the preferable current-carrying region 8 and heat dissipation region 9 within the range of L1/L2=0.2 to 0.9. However, more preferably, taking into consideration the coefficient of thermal conductivity of the heat generator 1 and the shape (the thickness t, the width W1, the current-carrying region 8, the heat dissipation region 9) of the heat generator 1, it is understood that the heat generator having an optimum resistance value and a heat generating temperature with small dispersion can be obtained by designing in the range of L1/L2=0.3 to 0.8. Further, the arranged distance L2 of the first current suppressing portion 2a is not always necessary to be the same distance over all the region of the heat generator 1, but can be appropriately set in correspondence to the specification and the intended use of the product using the heat generation unit.

In the case where the inflow of the current to the heat dissipation region 9 is small, and the heat generation in the current-carrying region 8 is hardly affected, in a state where apart of the first current suppressing portion 2a falls short, that is, in a state where the first current suppressing portion 2a is not formed continuously, or in a state where the coupled portion between the first current suppressing portion 2a and the third current suppressing portion 7a is not formed continuously, or in the case where it is not hard to set the resistance value for designing the product, it is understood that it is a state where only the current-carrying region 8 is substantially communicated.

### Embodiment 5

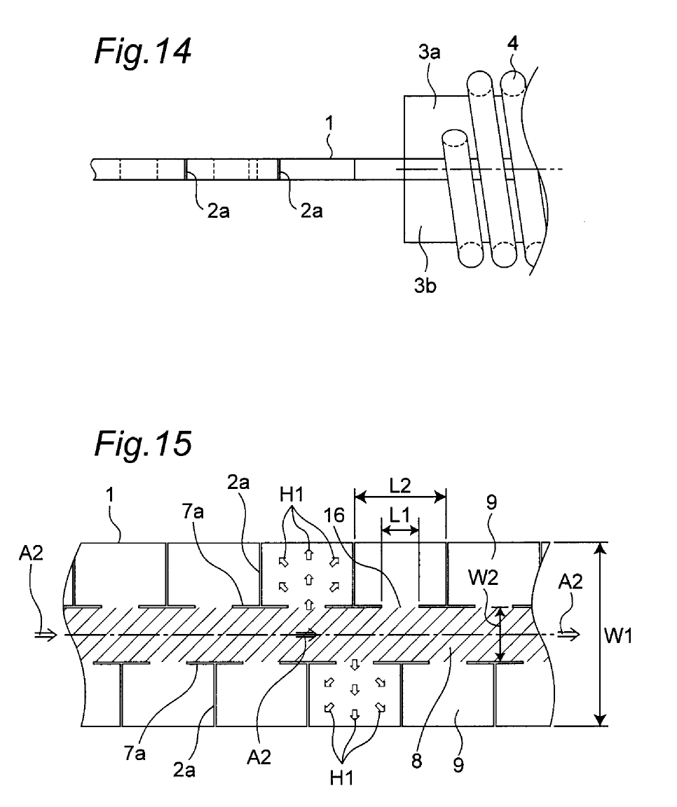

Next, a description will be given of a heat generation unit according to embodiment 5 of the present invention with reference to FIGS. 13 and 14. In the heat generation unit according to embodiment 5, a point different from the heat generation unit according to embodiment 1 mentioned above is a shear pattern of the current suppressing portion in the heat generator, and a point different from the heat generation unit according to embodiment 4 is a shear pattern of the heat generator near the holder. The other points in embodiment 5 are the same as those of the heat generation units according to embodiment 1 and embodiment 4. Accordingly, in the heat generation unit according to embodiment 5 described below, an overlapping description employs the descriptions of the heat generation units according to embodiment 1 and embodiment 4, and a description will be given only of the different points. In the description of the heat generation unit according to embodiment 5, the same reference numerals are used for the elements having the same functions and structures as the elements in the heat generation units according to embodiment 1 and embodiment 4.

FIG. 13 is a plan view showing the shear pattern of the current suppressing portion of the heat generator in the heat generation unit according to embodiment 5 of the present invention, and shows a portion near the holder in the heat generator. FIG. 14 is a front view showing a portion near the holder in the heat generator shown in FIG. 3. In the shear pattern of the heat generator according to embodiment 5, a point different from the shear pattern of the heat generator 1 according to embodiment 4 is a shape of the current suppressing portion of a region near the holding portion in the heat generator.

As shown in FIG. 13, in the heat generator 1 in the heat generation unit according to embodiment 5, a fourth current suppressing portion 7b is formed in continuation to the respective opposed end portions of the pair of first current suppressing portions 2a opposed to the region positioned near the holder 3 holding the end portion in such a manner as to become gradually narrower diagonally with respect to the band width direction of the heat generator 1. The fourth current suppressing portion 7b formed so as to have the same distance in both sides of the center axis which is in parallel to the longitudinal direction of the heat generator 1 is formed in such a manner as to be wider in a side closer to the holding portion 3 and narrower in the center portion side of the heat generator 1 in the opposite side. Further, the third current suppressing portion 7a is formed in the narrower side of the fourth current suppressing portion 7b so as to be along the longitudinal direction of the heat generator 1. Accordingly, the fourth current suppressing portion 7b gradually widens the width in the band width direction of the current-carrying region 8 formed between the third current suppressing portions 7a formed so as to be opposed, toward the holder side. As a result, in the region near the holder of the heat generator 1, the current-carrying region becomes gradually wider toward the holder side, and the resistance value of the heat generator 1 becomes gradually smaller. Accordingly, the heat generation unit according to embodiment 5 can prevent the heat generator 1 from being damaged by the thermal stress, and it is possible to provide a heat source having a long service life.

In the heat generator 1 shown in FIG. 13, the description is given of the example in which the fourth current suppressing portion 7b is formed in a linear shape having a fixed angle with respect to the first current suppressing portion 2a or the third current suppressing portion 7a, and is formed in the region near the holder, however, the present invention is not limited to this example. For example, the third current suppressing portion 7a and the fourth current suppressing portion 7b may have a curved shape constructed by a gentle curve.

Further, in FIG. 13, in the third current suppressing portion 7a constructing the T-shaped current suppressing portion together with the first current suppressing portion 2a, it is possible to employ a curved shape in which a center portion protrudes to the center side of the heat generator 1.

Further, in the heat generator 1 shown in FIG. 12 mentioned above, the T-shaped current suppressing portion is formed by the first current suppressing portion 2a and the third current suppressing portion 7a, however, the fourth current suppressing portion 7b may be formed by being inclined while setting an end portion in the holder side of the third current suppressing portion 7a to a starting point. In this case, the fourth current suppressing portion 7b may be formed in such a manner as to be inclined to an edge side direction of the heat generator 1 with respect to the longitudinal direction of the heat generator 1 in accordance with coming close to the holder 3.

As is described in detail in embodiment 1 mentioned above, since the heat generator according to the present invention is formed in the sheet shape having the carbon-based substance as the main component, it is easily worked. Accordingly, as described in the heat generator 1 shown in FIG. 8 mentioned above, even in the heat generator 1 shown in FIG. 13, in the case where the dimensions in the band width direction of the heat generator 1 and the holder 3 are different, it is possible to cut in such a manner as to form the inclined portion 1e in the heat generator 1 near the bonded portion between the heat generator 1 and the holder 3 as shown in FIG. 13. It is possible to prevent the heat generator 1 from damage by forming the inclined portion 1e near the bonded portion of the heat generator 1 as mentioned above, and it is possible to construct the heat generation unit having a long service life.

### Embodiment 6

Next, a description will be given of a heat generation unit according to embodiment 6 of the present invention with reference to FIG. 15. In the heat generation unit according to embodiment 6, a point different from the heat generation unit according to embodiment 1 mentioned above is a shear pattern of the current suppressing portion in the heat generator, and a point different from the heat generation unit according to embodiment 4 shown in FIG. 12 is a shear position of the current suppressing portion in the heat generator. The other points in embodiment 6 are the same as those of the heat generation units according to embodiment 1 and embodiment 4. Accordingly, in the heat generation unit according to embodiment 6 described below, an overlapping description employs the descriptions of the heat generation units according to embodiment 1 and embodiment 4, and a description will be given of the different points. In the description of the heat generation unit according to embodiment 6, the same reference numerals are used for the elements having the same functions and structures as the elements in the heat generation units according to embodiment 1 and embodiment 4.

FIG. 15 is a plan view showing the current suppressing portion of the heat generator 1 in the heat generation unit according to embodiment 6. In the heat generator 1 according to embodiment 6, the point different from the heat generator 1 according to embodiment 4 shown in FIG. 12 is an arrangement of the T-shaped current suppressing portion constructed by the first current suppressing portion 2a and the third current suppressing portion 7a, and the T-shaped current suppressing portions arranged so as to be opposed in the both edge side portions of the heat generator 1 is arranged alternately along the longitudinal direction of the heat generator 1 in embodiment 6.

As shown in FIG. 15, the first current suppressing portions 2a are formed in the both side edges of the heat generator 1 having the band width W1. The first current suppressing portions 2a are provided so as to extend alternately from the both side edges of the heat generator 1 toward the center axis which is in parallel to the longitudinal direction of the heat generator 1, as is different from the current suppressing portion 2a in the heat generator 1 shown in FIG. 12. In other words, the first current suppressing portions 2a extended from the both side edges of the heat generator 1 are not formed on the same line in the band width direction of the heat generator 1, but are formed alternately. In embodiment 6, a plurality of first current suppressing portions 2a are formed at the distance L2 in the longitudinal direction of the heat generator 1, and the second current suppressing portions 2a formed in the both edge sides of the heat generator 1 are arranged alternately so as to have a distance 1/2L.

The first current suppressing portions 2a extended from the both side edges of the heat generator 1 are arranged in such a manner that respective center side end portions have a predetermined distance, and the center side conduction path 8 is formed in the heat generator 1. The center side end portion of the first current suppressing portion 2a is connected to the third current suppressing portion 7a, and the T-shaped current suppressing portion is constructed by the first current suppressing portion 2a and the third current suppressing portion 7a. Accordingly, in the heat generator 1 in the heat generation unit according to embodiment 6, the center side conduction path 8 having the band width W2 in which the current flows in the center portion is formed in the heat generator 1 by the T-shaped current suppressing portion formed in the both side edges of the heat generator 1.

Accordingly, a plurality of the T-shaped current suppressing portions formed in the both side edges of the heat generator 1 are arranged in line so as to have the predetermined arrangement distance L2 along the longitudinal direction of the heat generator 1.

As mentioned above, since the first current suppressing portions 2a are formed in the both side edges of the heat generator 1 so as to have the arrangement distance L2 along the longitudinal direction of the heat generator 1, the current flowing in the longitudinal direction of the heat generator 1 is suppressed by the first current suppressing portions 2a in the heat generator 1 according to embodiment 6. Further, in the heat generator 1 according to embodiment 6, the third current suppressing portion 7a extended in the longitudinal direction of the heat generator 1 is formed in the center side end portion of the opposed first current suppressing portions 2a. Accordingly, the current-carrying region 8 (a diagonal line portion in FIG. 15) in which the current A2 flows is formed between the opposed third current suppressing portions 7a in the heat generator 1. The current-carrying region 8 that is the center side conduction path generates heat by the flowing of the current A2, and a predetermined heat quantity is generated.

In the heat generator 1 according to embodiment 6, two rows of the opposed third current suppressing portions 7a deciding the current-carrying region 8 that is the center side conduction path are formed on a line which is in parallel to the longitudinal direction. Further, the third current suppressing portions 7a are formed in such a manner as to be connected to the center side end portion of the first current suppressing portion 2a.

The T-shaped current suppressing portions constructed by the first current suppressing portions 2a and the third current suppressing portions 7a are formed in the opposed both side edge portions in the heat generator 1. The T-shaped current suppressing portions formed in the both side edge portions are arranged in line in respective edge portions. Further, the T-shaped current suppressing portion formed in one edge portion and the T-shaped current suppressing portion formed in the other edge portion are arranged so as to be alternate along the longitudinal direction of the heat generator 1. In two rows of the third current suppressing portions 7a arranged in line along the longitudinal direction of the heat generator, a conduction port 16 having a distance L1 by which the heat generated in the current-carrying region 8 is effectively transmitted is formed between the third current suppressing portions 7a which are adjacent in the longitudinal direction. Accordingly, the T-shaped current suppressing portions arranged in the both side edges become a two-row arrangement that are alternately arranged along the longitudinal direction of the heat generator 1, and each of the rows is constructed by a plurality of intermittently arranged T-shaped current suppressing portions. As a result, the heat dissipation region 9 having the length of the distance L2 surrounded by the T-shaped current suppressing portions is formed in the both side edge portions of the heat generator 1. The heat dissipation region 9 serves as a region to which the heat of the current-carrying region 8 is transmitted from the conduction port 16 so as to radiate heat.

As mentioned above, the point different between the current suppressing portion of the heat generator 1 according to embodiment 6 shown in FIG. 15 and the current suppressing portion of the heat generator 1 according to embodiment 4 shown in FIG. 12 is the arrangement of the T-shaped current suppressing portion constructed by the first current suppressing portion 2a and the third current suppressing portion 7a. The heat conduction from the current-carrying region 8 to the heat dissipation region 9 according to embodiment 4 has the same phase in the band width direction of the heat generator 1, however, the heat conduction from the current-carrying region 8 to the heat dissipation region 9 according to embodiment 6 has a different phase in the band width direction of the heat generator 1. This is because there is formed the two-row arrangement in which the T-shaped current suppressing portions are arranged alternately at the same distance along the longitudinal direction of the heat generator 1, in the structure according to embodiment 6. In other words, in the heat generator 1 according to embodiment 6, the heat dissipation regions 9 are formed alternately in two rows in each of the regions of the both side edge portions thereof, and the conduction ports 16 allowing the heat conduction from the current-carrying region 8 to the heat dissipation regions 9 in the both sides are alternately arranged. As a result, a dispersion of a resistance value in the longitudinal direction of the heat generator 1 according to embodiment 6 becomes even, and it is possible to set the resistance value more stably. Further, in the heat generator 1 according to embodiment 6, since the current-carrying paths conducting from the conduction port 16 to the heat dissipation region 9 are arranged alternately, the dispersion of the temperature distribution in a whole of the current-carrying region 8 and the heat generator 1 becomes further smaller, and it is possible to achieve the heat generation unit having a uniform heat generation region.

In embodiment 4 shown in FIG. 12, and embodiment 6 shown in FIG. 15, the arrangement distance L2 of the conduction port 16 of the first current suppressing portion 2a in the longitudinal direction of the heat generator 1 is not necessarily the same distance over the whole region of the heat generator 1, but may be appropriately set in correspondence to a specification and an intended use of the product using the heat generation unit.

Further, all of the first current suppressing portions 2a do not necessarily have the length reaching the edge in the bandwidth direction of the heat generator 1 from the third current suppressing portion 7a. For example, as long as it is not a current path in which the current flows while passing through the first current suppressing portion 2a in the whole longitudinal direction of the heat generator 1, the length of the first current suppressing portion 2a may be short. In other words, even if the first current suppressing portion 2a is not formed in the edge portion of the heat generator 1, and a portion where the current path is partly left exists in the edge portion of the heat generator 1, the effect of the present invention is not affected as long as the current path connected in the longitudinal direction is not formed in the whole of the heat generator 1.

### Embodiment 7

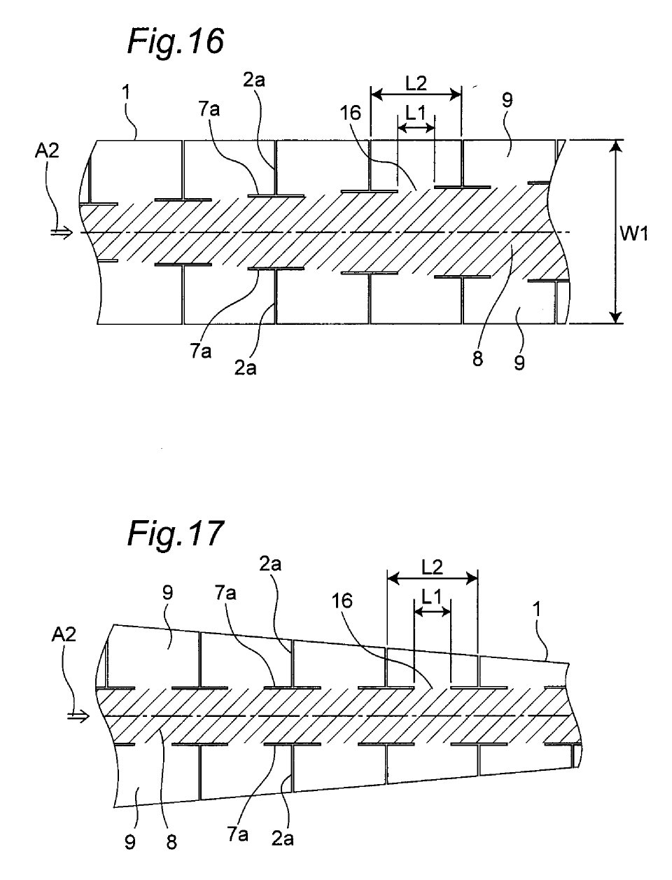

Next, a description will be given of a heat generation unit according to embodiment 7 of the present invention with reference to FIG. 16. In the heat generation unit according to embodiment 7, a point different from the heat generation unit according to embodiment 1 mentioned above is a shear pattern of the current suppressing portion in the heat generator, and a point different from the heat generation unit according to embodiment 4 shown in FIG. 12 is a shear position of the current suppressing portion. The other points in embodiment 7 are the same as those of the heat generation units according to embodiment 1 and embodiment 4. Accordingly, in the heat generation unit according to embodiment 7 described below, an overlapping description employs the descriptions of the heat generation units according to embodiment 1 and embodiment 4, and a description will be given of the different points. Therefore, in the description of the heat generation unit according to embodiment 7, the same reference numerals are used for the elements having the same functions and structures as the elements in the heat generation units according to embodiment 1 and embodiment 4.

FIG. 16 is a plan view showing the current suppressing portion of the heat generator 1 in the heat generation unit according to embodiment 7. The point different between the heat generator 1 according to embodiment 7 and the heat generator 1 according to embodiment 4 shown in FIG. 12 is a shear pattern of the first current suppressing portion 2a and the third current suppressing portion 7a which are respectively formed in the both side edge portions in the band width direction of the heat generator 1. In the heat generator 1 according to embodiment 7, an opposed distance gradually changes in a pair of opposed T-shaped current suppressing portions which are constructed by the first current suppressing portion 2a and the third current suppressing portion 7a. In other words, a width of a current-carrying region 8 (a region shown by a diagonal line in FIG. 16) decided by the third current suppressing portions 7a arranged so as to be opposed along the longitudinal direction of the heat generator 1 gradually changes.

As shown in FIG. 16, the T-shaped current suppressing portions are arranged respectively in the both side edge portions of the heat generator 1 along the longitudinal direction of the heat generator 1, and are arranged in two rows. The width of the current-carrying region 8 formed between the opposed third current suppressing portions 7a constructing a part of the T-shaped current suppressing portion gradually changes.

In the heat generator 1 according to embodiment 7, the arranged position of the third current suppressing portion 7a constructing a part of the T-shaped current suppressing portion is gradually moved in a direction coming close to the edge of the heat generator 1. Accordingly, the opposed distance of the opposed third current suppressing portions 7a becomes gradually longer, and the width of the current-carrying region 8 becomes gradually wider. At this time, a length of the first current suppressing portion 2a constructing the other part of the T-shaped current suppressing portion changes in accordance with a movement of the arranged position of the third current suppressing portion 7a. As shown in FIG. 16, the width of the current-carrying region 8 of the heat generator 1 varies in accordance with the arranged position. In FIG. 16, the resistance value becomes higher in the current-carrying region 8 shown in a left side, that is, the narrower current-carrying region 8, and on the contrary, the resistance value becomes lower in the current-carrying region 8 shown in a right side, that is, the wider current-carrying region 8. As a result, since the same current flows in the whole of the heat generator 1 according to embodiment 7 shown in FIG. 16, the left current-carrying region 8 comes to have a high temperature due to the high resistance value, and the right current-carrying region 8 comes to have a low temperature due to the low resistance value. Accordingly, in the heat generator 1 according to embodiment 7, the temperature varies in accordance with the position, and it is possible to obtain a continuously changing temperature distribution. In other words, in the heat generation unit according to embodiment 7, it is possible to achieve a desired temperature distribution in the longitudinal direction of the heat generator 1 for use.

In the same manner as the heat generator 1 according to embodiment 4 shown in FIG. 12, the arranged distance L2 of the first current suppressing portion 2a is not necessarily set to the same distance over the entire heat generator 1, and can be appropriately set in correspondence to the specification and the intended use of the product using the heat generation unit.

Further, all of the first current suppressing portions 2a do not necessarily have the length extended from the third current suppressing portion 7a so as to reach the edge in the band width direction of the heat generator 1. For example, as long as it is not a current path in which the current flows while passing through the first current suppressing portion 2a in the whole longitudinal direction of the heat generator 1, the length of the first current suppressing portion 2a may be short. In other words, even if the first current suppressing portion 2a is not formed in the edge portion of the heat generator 1, and a portion where the current path is partly left exists in the edge portion of the heat generator 1, the effect of the present invention is not affected as long as the current path connected in the longitudinal direction is not formed in the whole of the heat generator 1.

Further, in the same manner as the heat generator 1 according to embodiment 6 shown in FIG. 15, two rows of the T-shaped opposed current suppressing portions may be arranged alternately with respect to the longitudinal direction of the heat generator 1.

### Embodiment 8

Next, a description will be given of a heat generation unit according to embodiment 8 of the present invention with reference to FIG. 17. In the heat generation unit according to embodiment 8, a point different from the heat generation unit according to embodiment 1 mentioned above is a shear pattern of the current suppressing portion in the heat generator, and a point different from the heat generation unit according to embodiment 4 shown in FIG. 12 is a shape of the heat generator 1. The other points in embodiment 8 are the same as those of the heat generation units according to embodiment 1 and embodiment 4. Accordingly, in the heat generation unit according to embodiment 8 described below, an overlapping description employs the descriptions of the heat generation units according to embodiment 1 and embodiment 4, and a description will be given of the different points. In the description of the heat generation unit according to embodiment 8, the same reference numerals are used for the elements having the same functions and structures as the elements in the heat generation units according to embodiment 1 and embodiment 4.

FIG. 17 is a plan view showing the current suppressing portion of the heat generator 1 in the heat generation unit according to embodiment 8. As shown in FIG. 17, in the heat generator 1 according to embodiment 8, a width (a length in a vertical direction of the heat generator 1 in FIG. 17) that is the length in the bandwidth direction gradually changes along the longitudinal direction of the heat generator 1. In the heat generator 1 shown in FIG. 17, a left width is wider, and is gradually narrowed toward a rightward direction. Further, in the heat generator 1 according to embodiment 8, the T-shaped current suppressing portions constructed by the first current suppressing portions 2a and the third current suppressing portions 7a are formed in two rows in such a manner as to be opposed to the both side edge portions of the heat generator 1. Accordingly, the width of the current-carrying region 8 that is the center side conduction path formed by the T-shaped current suppressing portion is set to the same length at any positions in the longitudinal direction of the heat generator 1.

In the heat generator 1 according to embodiment 8, the pair of opposed first current suppressing portions 2a formed in the both side edge portions of the heat generator 1 are formed on the same line which is orthogonal to the longitudinal direction of the heat generator 1. Further, a plurality of the first current suppressing portions 2a are arranged in line so as to have a predetermined arranged distance L2 along the longitudinal direction of the heat generator 1. Accordingly, the current flowing in the longitudinal direction in the both side edge portions of the heat generator 1 is blocked by the first current suppressing portion 2a, and the current flowing in the longitudinal direction in the whole of the heat generator 1 is suppressed.

In the heat generator 1 according to embodiment 8, in the pair of first current suppressing portions 2a provided so as to be opposed, a distance (a distance in the band width direction of the heat generator 1) between the opposed end portions is set in such a manner as to be fixed at any positions in the longitudinal direction of the heat generator 1. Further, the third current suppressing portions 7a are provided in the opposed end portions of the pair of first current suppressing portions 2a provided so as to be opposed, whereby the T-shaped current suppressing portion is formed. The T-shaped current suppressing portion is provided so as to have the fixed distance (L2) along the longitudinal direction of the heat generator 1, and a pair of T-shaped current suppressing portions formed in the both side edge portions of the heat generator 1 are arranged so as to be opposed while having the same distance.

The current-carrying region 8 (the diagonal portion in FIG. 17) allowing a predetermined heat generation by the flow of the current A2 and having the fixed width is formed between the second opposed current suppressing portions 7a according to embodiment 8 constructed as mentioned above.

In the heat generation unit according to embodiment 8 constructed as mentioned above, the width of the current-carrying region 8 of the heat generator 1 is fixed, and the width, that is, the heat dissipation area of the heat dissipation region 9 varies. Accordingly, in the left heat dissipation region 9 in the heat generator 1 shown in FIG. 17, the area becomes wider, and the heat dissipation amount becomes large. On the contrary, in the right heat dissipation region 9 in the heat generator 1, the area becomes narrower, and the heat dissipation amount becomes smaller. In other words, since the same current flows in the whole of the heat generator, however, the left region in FIG. 17 comes to have the low temperature due to the large heat dissipation amount, and the right region comes to have the high temperature due to the small heat dissipation amount. As mentioned above, in the heat generator 1 according to embodiment 8, it is possible to obtain a continuously changing temperature distribution in which the temperature varies according to the position. In other words, in the same manner as the heat generator 1 according to embodiment 7 shown in FIG. 16, in the heat generation unit according to embodiment 8, a desired temperature distribution can be achieved in the longitudinal direction of the heat generator 1 for use.

In the same manner as the heat generator 1 according to embodiment 4 shown in FIG. 12, the arranged distance L2 of the first current suppressing portion 2a is not necessarily the same distance over the entire region of the heat generator 1, but can be appropriately set in accordance with the specification and the intended use of the product using the heat generation unit.

Further, all of the first current suppressing portions 2a do not necessarily have the length extended from the third current suppressing portion 7a so as to reach the edge in the band width direction of the heat generator 1. For example, the length of the first current suppressing portion 2a may be short as long as it is not a current path in which the current flows while passing through the first current suppressing portion 2a in the whole longitudinal direction of the heat generator 1. In other words, even if the first current suppressing portion 2a is not formed in the edge portion of the heat generator 1, but the portion where the current path is partly left exists in the edge portion of the heat generator 1, the effect of the present invention is not affected as long as the current path connected in the longitudinal direction is not formed in the whole of the heat generator 1.

Further, in the same manner as the heat generator 1 according to embodiment 6 shown in FIG. 15, two rows of opposed T-shaped current suppressing portions can be arranged alternately with respect to the longitudinal direction of the heat generator 1.

In the case where there is such a purpose that it is desired to unevenly change the heat distribution in the longitudinal direction of the heat generator 1, it is not necessary to change the width that is the length in the band width direction of the heat generator 1 at the same angle of gradient along the longitudinal direction. In this case, not only the edge shape of the heat generator 1 is structured linearly, but also it is possible to employ various shapes using a curve or the like. In this case, it is possible to achieve the current-carrying region and the heat dissipation region having the desired shape, by regulating the length of the first current suppressing portion 2a.

### Embodiment 9

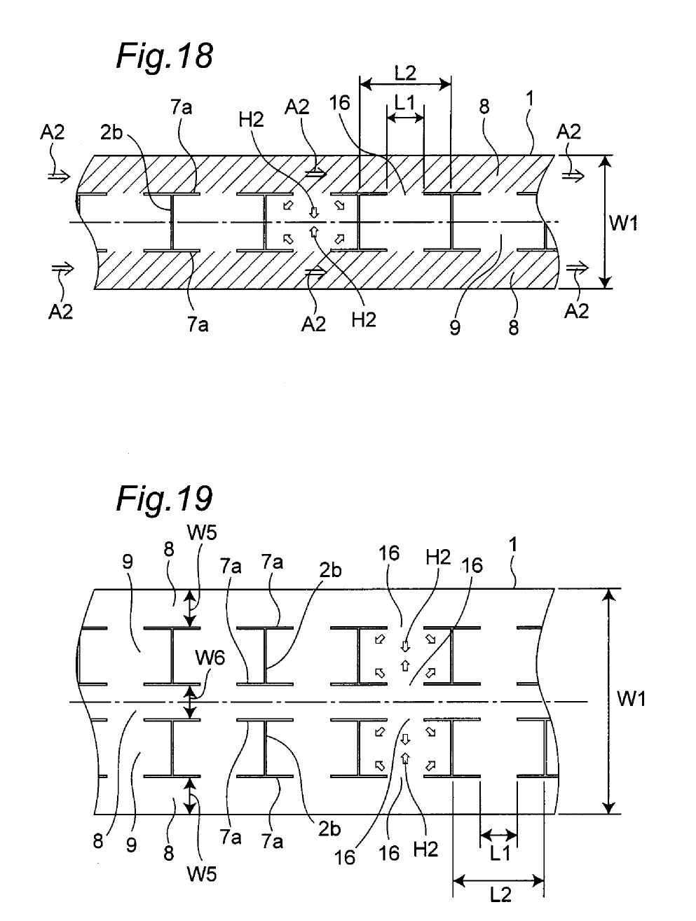

Next, a description will be given of a heat generation unit according to embodiment 9 of the present invention with reference to FIG. 18. In the heat generation unit according to embodiment 9, a point different from the heat generation unit according to embodiment 1 mentioned above is a shear pattern of the current suppressing portion in the heat generator, and a point different from the heat generation unit according to embodiment 4 shown in FIG. 12 is a position and a shape of the current suppressing portion in the heat generator. The other points in embodiment 9 are the same as those of the heat generation units according to embodiment 1 and embodiment 4. Accordingly, in the heat generation unit according to embodiment 9 described below, an overlapping description employs the descriptions of the heat generation units according to embodiment 1 and embodiment 4, and a description will be given of the different points. In the description of the heat generation unit according to embodiment 9, the same reference numerals are used for the elements having the same functions and structures as the elements in the heat generation units according to embodiment 1 and embodiment 4.

FIG. 18 is a plan view showing the current suppressing portion of the heat generator 1 in the heat generation unit according to embodiment 9.

As shown in FIG. 18, in the heat generator 1 according to embodiment 9, a second current suppressing portion 2b extended linearly in a direction which is orthogonal to the longitudinal direction is formed in the center portion in such a manner as to stride over a center axis which is in parallel to the longitudinal direction of the heat generator 1. Further, The third current suppressing portions 7a are formed respectively in the both end portions of the second current suppressing portion 2b, in the heat generator 1 according to embodiment 9. Accordingly, in the heat generator 1 according to embodiment 9, an H-shaped current suppressing portion constructed by the second current suppressing portion 2b and two third current suppressing portions 7a is formed. The H-shaped current suppressing portion is formed in the center portion in the band width direction (a direction which is orthogonal to the longitudinal direction) in the heat generator 1, and a plurality of the H-shaped current suppressing portions are arranged in a single row along the longitudinal direction of the heat generator 1. The second current suppressing portion 2b of the heat generator 1 according to embodiment 9 is the same as the heat generator 1 shown in FIG. 6 mentioned above. In other words, the second current suppressing portion 2b is formed in the center portion in such a manner as to intersect the center axis which is in parallel to the longitudinal direction of the heat generator 1, and the both end portions are extended in a direction which is orthogonal to the longitudinal direction of the heat generator 1. The both end portions of the second current suppressing portions 2b have a predetermined distance from the both side edges of the heat generator 1, and the current-carrying region 8 is formed between the end portion of the second current suppressing portion 2b and the edge of the heat generator 1. The second current suppressing portion 2b is continuously arranged so as to have a predetermined distance L2 along the longitudinal direction of the heat generator 1.

As mentioned above, in the heat generator 1 according to embodiment 9, the third current suppressing portions 7a are formed in the both end portions of the second current suppressing portion 2b formed continuously along the longitudinal direction of the heat generator 1 so as to be connected. The third current suppressing portions 7a are extended along the longitudinal direction of the heat generator 1, and the H-shaped current suppressing portion is continuously formed in the center portion of the heat generator along the longitudinal direction by the second current suppressing portion 2b and the third current suppressing portion 7a. In the current suppressing portion formed as mentioned above, a region where the current suppressing portion is not formed is formed in each of regions between the third current suppressing portions 7a in the both sides and the both side edges of the heat generator 1. The region comes to an edge side conduction path in which the current A2 flows in the heat generator 1. Further, the edge side conduction path serves as the current-carrying region 8 in which the heat is generated by the current A2.

In the heat generator 1 according to embodiment 9, the pair of third current suppressing portions 7a formed in the both sides of the second current suppressing portion 2b are formed in parallel to each other, and are extended uniformly in the longitudinal direction of the heat generator 1 while setting the second current suppressing portion 2b to a symmetric axis. Further, the third current suppressing portion 7a is coupled to the end portion of the second current suppressing portion 2b, and is formed in such a manner as to be connected to the second current suppressing portion 2b.

Further, a predetermined distance L1 is provided in such a manner that a plurality of the third current suppressing portions 7a arranged along the longitudinal direction of the heat generator 1 are not connected there between. In the conduction path in the band width direction having the predetermined distance L1, the heat generated in the current-carrying region 8 is conducted to the heat dissipation region 9 that is the region surrounded by the adjacent H-shaped current suppressing portions through the conduction path having the predetermined distance L1. In FIG. 18, the heat is conducted in a direction shown by an arrow H2. Accordingly, a portion between the adjacent third current suppressing portions 7a becomes a conduction port 16 having the distance L1 and forming an inlet of the heat from the current-carrying region 8 to the heat dissipation region 9.

In the heat generator 1 according to embodiment 9 constructed as mentioned above, the heat generated in the current-carrying region 8 upon energization is conducted from the current-carrying region 8 to the heat dissipation region 9 through the conduction port 16, as shown by the arrow H2 in FIG. 18. In the heat dissipation region 9, a fixed temperature is reached and the heat is radiated outward. As mentioned above, in the heat generator 1 according to embodiment 9, the heat generator 1 having a high wattage can be constructed by providing the current-carrying region 8 generating heat upon energization, and the heat dissipation region 9 to which the heat generated by the current-carrying region 8 is conducted so as to be radiated.

Further, in the heat generator 1 according to embodiment 9, since the current-carrying region 8 in which the current suppressing portion is not formed, that is, the portion in which the heat generators 1 are continuously connected is formed in the both side edge portions of the heat generator 1, the heat generator 1 becomes a heat source being strong to a torsion and having a mechanical strength with respect to a rupture at the time of working and assembling.

Further, in embodiment 9, a relationship between the arranged distance L2 of the second current suppressing portion 2b in the longitudinal direction of the heat generator 1, and the distance L1 of the conduction port 16 formed by the third current suppressing portion 7a in the longitudinal direction of the heat generator 1 varies in accordance with a material, however, the desired current-carrying region 8 and heat dissipation region 9 in the heat generation unit according to the present invention can be constructed by setting to a range L1/L2=0.2 to 0.9. For example, in the case where L1/L2 is smaller than 0.2, it is not possible to sufficiently, conduct the heat generated by energization, and an effective heat dissipation cannot be obtained. Further, a temperature difference is generated in the boundary portion between the current-carrying region 8 and the heat dissipation region 9, and there is generated a risk that the heat generator 1 is ruptured. On the contrary, in the case where L1/L2 is larger than 0.9, the current flows in the heat dissipation region 9, a further greater current than the current to actually flow only in the current-carrying region 8 flows, and it is hard to forecast the resistance value of a whole of the heat generator. It is preferable to construct the current-carrying region 8 and the heat dissipation region 9 in the heat generation unit according to the present invention within the range L1/L2=0.2 to 0.9, however, more preferably, it is possible to obtain the heat generator 1 having an optimum resistance value and a heat generation temperature with a small dispersion, by designing within the range of L1/L2=0.3 to 0.8.

Further, the arranged distance L2 of the second current suppressing portion 2b is not necessarily the same distance over the entire region in the longitudinal direction of the heat generator 1, but can be appropriately set in correspondence to the specification and the intended use of the product using the heat generation unit.

Further, it is not necessary that the second current suppressing portion 2b is formed between all of the opposed third current suppressing portions 7a. Even if there is a position where the second current suppressing portion 2b does not exist between the opposed third current suppressing portions 7a, the effect of the present invention is not affected as long as the current path connected in the longitudinal direction is not formed in the whole of the heat generator 1.

In the heat generator 1 shown in FIG. 18, the description is given of the example in which the third current suppressing portion 7a is formed in the both sides of the second current suppressing portion 2b, however, the third current suppressing portion 7a may be formed only in one side of the second current suppressing portion 2b. In the heat generator 1 constructed as mentioned above, since the second current suppressing portion 2b and the third current suppressing portion 7a are formed at the positions at which the strain is hard to be generated with respect to the heat generator 1, the heat generator 1 has excellent stability with respect to the torsion and the deformation of the heat generator 1, and it is possible to provide a heat generation unit in which a desired temperature distribution can be set, by appropriately selecting the dimensions of the second current suppressing portion 2b and the third current suppressing portion 7a or the formed positions.

### Embodiment 10

Next, a description will be given of a heat generation unit according to embodiment 10 of the present invention with reference to FIG. 19. In the heat generation unit according to embodiment 10, a point different from the heat generation unit according to embodiment 9 mentioned above is that the H-shaped current suppressing portions constructed by the second current suppressing portions 2b and the third current suppressing portions 7a are formed in plural rows. The other points in embodiment 10 are the same as those of the heat generation unit according to embodiment 9. Accordingly, in the heat generation unit according to embodiment 10 described below, an overlapping description employs the description of the heat generation unit according to each of the embodiments mentioned above, and a description will be given of the different point. In the description of the heat generation unit according to embodiment 10, the same reference numerals are used for the elements having the same functions and structures as the elements in the heat generation unit according to each of the embodiments mentioned above.

FIG. 19 is a plan view showing the current suppressing portion of the heat generator 1 in the heat generation unit according to embodiment 10. In the heat generator 1 according to embodiment 10, a plurality of H-shaped current suppressing portions each constructed by a second current suppressing portion 2b extended in a direction (a band width direction) which is orthogonal to the longitudinal direction of the heat generator 1, and opposed third current suppressing portions 7a formed in the both end portions of the second current suppressing portion 2b are formed, and are arranged in two rows.

In the two rows of H-shaped current suppressing portions, the second current suppressing portion 2b in each of the rows is arranged on the same line which is orthogonal to the longitudinal direction of the heat generator 1, and two rows of H-shaped current suppressing portions are arranged in the both sides while setting a center axis which is in parallel to the longitudinal direction of the heat generator 1 in the middle. A plurality of H-shaped current suppressing portions in each of the rows are intermittently arranged so as to have a predetermined distance along the longitudinal direction of the heat generator 1.

Accordingly, the H-shaped current suppressing portion in each of the rows according to embodiment 10 has the same structure' as the structure of the H-shaped current suppressing portion shown in FIG. 18. The second current suppressing portion 2b constructing a part of the H-shaped current suppressing portion is arranged in a direction which is orthogonal to the longitudinal direction of the heat generator 1, and the second current suppressing portion 2b in each of the rows is arranged on the same straight line which is orthogonal to the longitudinal direction of the heat generator 1. Further, the second current suppressing portions 2b are arranged at symmetric positions with respect to a center line in the longitudinal direction in the heat generator 1 so as to be opposed, and are formed in two rows along the longitudinal direction of the heat generator 1. Each of edge side end portions of the heat generator 1 in the second current suppressing portions 2b formed in two rows has a predetermined distance W5 with respect to an edge of the heat generator 1, and a margin portion is formed in the edge side in the heat generator 1. Further, center side end portions in the second current suppressing portions 2b formed in two rows are arranged symmetrically with respect to a center line which is in parallel to the longitudinal direction of the heat generator 1, and a margin portion is formed in a center side having a predetermined distance W6 between the second current suppressing portions 2b formed in two rows in the heat generator 1.

In the current suppressing portion in each of the rows of the heat generator 1 according to embodiment 10, the adjacent second current suppressing portions 2b are arranged so as to have a predetermined distance L2 along the longitudinal direction of the heat generator 1, and the second current suppressing portions 2b arranged in a single row while having the predetermined distance L2 are arranged in a parallel state symmetrically with respect to the center line which is in parallel to the longitudinal direction of the heat generator 1.

On the other hand, the third current suppressing portions 7a constructing a part of the H-shaped current suppressing portion are formed in such a manner as to be coupled to the both end portions of each of the second current suppressing portions 2b in two rows. The pair of opposed third current suppressing portions 7a formed so as to have the second current suppressing portion 2b therebetween are extended along the longitudinal direction of the heat generator 1. As a result, the H-shaped current suppressing portion is formed by one second current suppressing portion 2b and two third current suppressing portions 7a as mentioned above.

Accordingly, an edge side margin portion is formed between the third current suppressing portions 7a in both side edge portions in the H-shaped current suppressing portions in two rows and the both side edges of the heat generator 1. Further, in the H-shaped current suppressing portions in two rows, a center side margin portion is formed between two third current suppressing portions 7a which are opposed with respect to the center line which is in parallel to the longitudinal direction of the heat generator 1.

In the heat generator 1 in which two rows of H-shaped current suppressing portions are formed as mentioned above, when a voltage is applied to the both ends of the heat generator 1, the edge side margin portion becomes an edge side conduction path in which the current A2 flows, and the center side margin portion becomes a center side conduction path in which the current A2 flows. Accordingly, in the heat generator 1 according to embodiment 10, the edge side conduction path and the center side conduction path become the current-carrying region 8 in which the heat is generated.

As mentioned above, in embodiment 10, the pair of third current suppressing portions 7a formed in the both sides of the second current suppressing portion 2b are arranged in parallel to each other, and each of the third current suppressing portions 7a is extended uniformly in the longitudinal direction of the heat generator 1 while setting the second current suppressing portion 2b to a symmetric axis. Further, the third current suppressing portion 7a is coupled to the end portion of the second current suppressing portion 2b, and is formed in such a manner as to be connected to the second current suppressing portion 2b.

In the heat generator 1 according to embodiment 10, a predetermined distance L1 is provided between the end portions of the third current suppressing portions 7a arranged on the straight line along the longitudinal direction of the heat generator 1, and the adjacent third current suppressing portions 7a are arranged in such a manner that they are not connected. Accordingly, a conduction path is formed between the third current suppressing portions 7a which are adjacent along the longitudinal direction of the heat generator 1. The conduction path serves as an inlet by which the heat generated in the current-carrying region 8 is effectively conducted to each of the heat dissipation regions 9 surrounded by the adjacent H-shaped current suppressing portions which are arranged so as to have the predetermined distance L2 (shown by an arrow H2). This inlet becomes a heat conduction port 16 having the distance L1.

The heat generator 1 according to embodiment 10 structured as mentioned above has the effect of the heat generator 1 according to embodiment 9 shown in FIG. 18 mentioned above, has a high wattage, is strong in torsion, and becomes a heat source having a longer service life.

### Embodiment 11

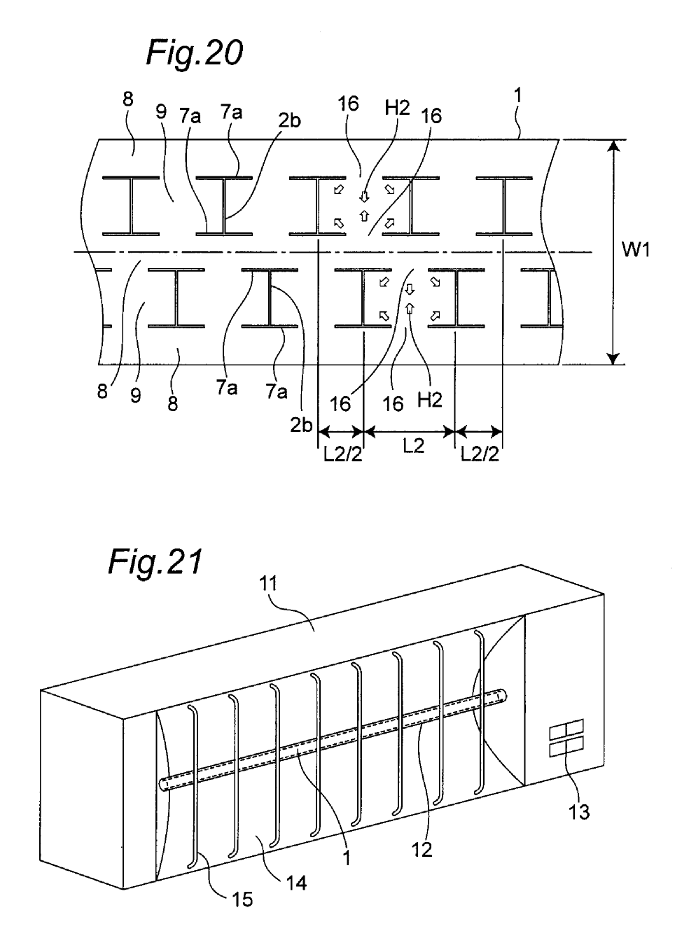

Next, a description will be given of a heat generation unit according to embodiment 11 of the present invention with reference to FIG. 20. In the heat generation unit according to embodiment 11, a point different from the heat generation unit according to embodiment 10 mentioned above is an arrangement of the H-shaped current suppressing portion constructed by the second current suppressing portion 2b and the third current suppressing portion 7a. The other points in embodiment 11 are the same as those of the heat generation unit according to embodiment 10. Accordingly, in the heat generation unit according to embodiment 11 described below, an overlapping description employs the description of the heat generation unit according to each of the embodiments mentioned above, and a description will be given of the different point. In the description of the heat generation unit according to embodiment 11, the same reference numerals are used for the elements having the same functions and structures as the elements in the heat generation unit according to each of the embodiments mentioned above.

FIG. 20 is a plan view showing the current suppressing portion in the heat generation unit according to embodiment 11. As shown in FIG. 20, in the heat generator 1 according to embodiment 11, a point different from the heat generator 1 according to embodiment 10 shown in FIG. 19 is that the respective H-shaped current suppressing portions are arranged not in the opposed positions but are arranged alternately in the H-shaped current suppressing portions arranged in two rows along the longitudinal direction. In other words, in the case where that adjacent second current suppressing portions 2b in two rows of H-shaped current suppressing portions are arranged at the distance L2 in the longitudinal direction, the second current suppressing portion 2b in the H-shaped current suppressing portion in one row is formed at an intermediate position of the adjacent second current suppressing portions 2b in the H-shaped current suppressing portion in the other row. Accordingly, the second current suppressing portion 2b in the H-shaped current suppressing portion in one row and the second current suppressing portion 2b in the H-shaped current suppressing portion in the other row are arranged in such a manner that the distance in the longitudinal direction of the heat generator 1 is ½ of L2.

In two rows of H-shaped current suppressing portions of the heat generator 1 according to embodiment 11 structured as mentioned above, the heat dissipation region 9 surrounded by the adjacent H-shaped current suppressing portions in one row and its conduction port 16, and the heat dissipation region 9 surrounded by the adjacent H-shaped current suppressing portions in the other row and its conduction port 16 are arranged alternately. Accordingly, the heat generator 1 according to embodiment 11 has the effect of embodiment 9 shown in FIG. 18 mentioned above, a dispersion of the resistance value in the longitudinal direction of the heat generator 1 becomes uniform, and it is possible to set the resistance value more stably. Further, it is possible to construct the heat generation unit having a small dispersion of the temperature distribution in the heat generator 1, by using the heat generator 1 according to embodiment 11.

In the heat generator used in the heat generation unit according to each of the embodiments of the present invention, a round shaped curved surface work may be applied to a portion (an intersecting portion) where the first current suppressing portion 2a and the third current suppressing portion 7a, or the second current suppressing portion 2b and the third current suppressing portion 7a are coupled, or a circular hole work may be applied thereto. It is possible to prevent a micro crack which is generated by thermal expansion and thermal contraction in the heat generator, by employing the work mentioned above, whereby it is possible to achieve a long service life of the heat generator.

Next, a description will be given in detail of the materials of the heat generator 1, the holder, the power supply portion, the container and the like which are used in the heat generation unit according to each of the embodiments of the present invention.

The heat generator 1 of the band-shaped film sheet raw material used in the heat generation unit according to the present invention has a thickness equal to or less than 300 μm, and predetermined width and length, and various shapes are used in correspondence to a design specification of the heat generation unit. The heat generator 1 is constructed while having a natural graphite and an artificial graphite having a carbon as a main component. Preferably, in the case of the natural graphite, it is a natural graphite having a crystalline graphite as a main component, and in the case of the artificial graphite, it is an artificial graphite having a crystalline graphite obtained by firing a high polymer film as a main component. In any cases, the film sheet raw material of the heat generator 1 may employ a material which is pressurized or metal rolled as necessary.

Further, as the heat generator 1 used in the heat generation unit according to the present invention, a material in which a coefficient of thermal conductivity in the surface direction is equal to or more than 600 W/mK, and a coefficient of thermal conductivity in the thickness direction is equal to or more than 15 W/mK is desirable. In the case where the coefficient of thermal conductivity of the heat generator 1 is lower than the value mentioned above, a sufficient heat dissipation effect cannot be achieved, and the sheet-like heat generator having the great dispersion of the temperature distribution is obtained.

In each of the embodiments according to the heat generation unit of the present invention, the holder for holding the heat generator 1 and the power supply portion are constructed by a metal or a carbon which is excellent in an electrical conductivity and a heat resistance, and is easily machine worked and/or welded, and desirably employ a simple substance such as Mo, W, Pt, Ni, stainless C (carbon) or the like, an alloy thereof, or a material obtained by plating the above. The shapes of the holder and the power supply portion are not limited particularly, but are appropriately formed by using a linear material, a tabular material, a rod material, a metal foil or the like.

In the holder 3 (refer to FIG. 1) in the heat generation unit according to the present invention, a columnar carbon material is divided into two parts in its longitudinal direction in such a manner as to pinch the end portion of the heat generator 1 from both sides. In each of the embodiments according to the present invention, the heat generator 1 can be easily pinched by the holder 3 by pressure inserting the coil shape portion 4 provided in one end of the power supply portion formed by the wire rod so as to wind around and attach to the outer surface of the holder 3, in a state where the end portion of the heat generator 1 is pinched by the holder 3 divided in two parts.

The shape or the structure of the holder 3 is not limited to that described in each of the embodiments, but may employ any structure as long as the holder 3 can sufficiently hold the end portion of the heat generator 1.

In the power supply portion 5 (refer to FIG. 1) in the heat generation unit according to the present invention, the coil shape portion 4 (refer to FIG. 1) winding and attaching the outer surface of the holder 3 is formed in one end for holding the holder 3, and a lead wire portion to which an external lead wire supplying power from an external portion is connected is formed in the other end. The coil shape portion 4 not only absorbs thermal expansion of the heat generator itself, but is also effective for securing a tensile force at the time of assembling.

The container 6 in the heat generation unit according to the present invention is constructed by a glass having a heat resistance and an insulating property, and is selected from glasses such as a quartz glass, a soda lime glass, a borosilicate glass, a lead glass and the like.

An inert gas charged within the container in the heat generation unit according to the present invention is a single gas selected from an argon gas, a helium gas, a neon gas, a krypton gas, a nitrogen gas and the like, or a mixed gas thereof.

### Embodiment 12

A description will be given below of a heating apparatus according to embodiment 12 of the present invention with reference to FIG. 21. FIG. 21 is an outer appearance perspective view showing an example of the heating apparatus equipped with the heat generation units which are described in embodiment 1 to embodiment 11.

In FIG. 21, an inner portion of a heating apparatus 11 for heating purpose as one example of a heating apparatus is equipped with the same heat generation unit 12 as the heat generation unit described in embodiments 1 to 11 as a heat source. Further, the heating apparatus 11 is provided with elements used in a general heating apparatus for heating purpose such as a temperature controller 13, a reflective plate 14, a protecting cover 15 and the like.

In the heating apparatus 11 according to embodiment 12 structured as mentioned above, a predetermined current flows in the heat generator 1 of the heat generation unit 12 so as to generate heat by applying a rated voltage to the heat generation unit 12 that is the heat source, whereby a temperature of the heat generator 1 rises. In the heating apparatus 11 according to embodiment 12, the heat generator 1 is held at a fixed temperature by temperature control of the temperature controller 13.

As an example of the apparatus equipped with the heat generation unit according to the present invention, the heating apparatus for heating purpose is shown in embodiment 12, however, the present invention is not limited to this example, but can be utilized, for example, in an OA device such as a copying machine, a printer and the like, a heating cooking device, a drying machine, a humidifier and the like, which is equipped with the heat generator having a high temperature.

### Embodiment 13

Next, a description will be given of a preferred embodiment of an image fixing apparatus that is the heating apparatus according to the present invention, and an image forming apparatus using the image fixing apparatus with reference to the accompanying drawings. The image fixing apparatus that is the heating apparatus described herein and the image forming apparatus have the heat generator in the heat generation unit described in embodiment 1 to embodiment 11 mentioned above as the heat source. Further, the heat generation unit described in embodiment 1 to embodiment 11 mentioned above can be used as the heat generation unit in the image fixing apparatus according to embodiment 13, however, a holder having the other structure is used as a holder pinching (holding) the heat generator 1, in embodiment 13. A detail of the holder will be described later.

The inventors of the present invention applies a new film sheet-like material (a film sheet raw material) which is completely different in a material and a manufacturing method from the heat generator used in the conventional image fixing apparatus as the heat generating material to the heat generator, as mentioned above. The film sheet-like material (the film sheet raw material) which is to be applied to the heat generator used in the heat generation unit as the new heat source of the image fixing apparatus has high efficiency and a high temperature, has a reduced heat quantity due to a light and thin structure, and has an excellent rising characteristic, as mentioned above.

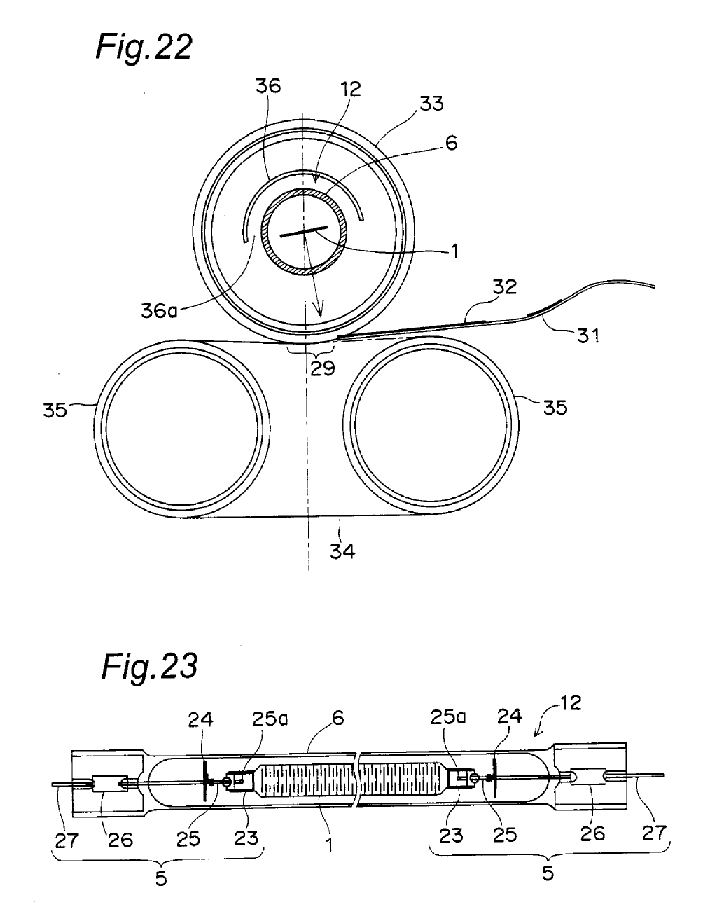

A description will be given of an image fixing apparatus according to embodiment 13 of the present invention with reference to FIGS. 22 to 24.

In an image forming process of the image forming apparatus, an electrostatic latent image designated by an exposure device is formed on a surface of a photosensitive drum which is uniformly sealed by a sealing device, and a toner image is formed by a developing device in correspondence to the electrostatic latent image. The toner image formed on the photosensitive drum surface is transferred onto a member to be recorded such as conveyed paper or the like by a transfer device. The member to be recorded, for example, the paper carrying an unfixed toner image transferred as mentioned above is conveyed to the image fixing apparatus carrying out the image fixing. The image fixing apparatus pressurizes and heats the member to be recorded carrying the unfixed toner image so as to fix the unfixed toner image on the member to be recorded.

A description will be given of an image forming process of a single color image in embodiment 13. In the case of the image forming process of the color image, four sets of the photosensitive drums mentioned above are provided in line in such a manner as to correspond to four color toners, and are structured such that the toner image of each of the colors is sequentially transferred to the transfer belt, and the color image is sequentially transferred on the member to be recorded. The color image transferred onto the member to be recorded is pressurized and heated so as to be fixed in the image fixing apparatus.

FIG. 22 is a view showing a main structure in the image fixing apparatus according to embodiment 13. As mentioned above, the image fixing apparatus heats at a high temperature a member 31 to be recorded carrying an unfixed toner image 32 as well as pressurizing, melts the unfixed toner image 32, and fixes to the member 31 to be recorded, in the image forming process.

In FIG. 22, the image fixing apparatus according to embodiment 13 is provided with a fixing roller 33 that is a heating body heating the unfixed toner image 32 carried on the member 31 to be recorded so as to melt, a pressurizing belt 34 pressing the member 31 to be recorded carrying the unfixed toner image 32 to the fixing roller 33 so as to pressurize, and pressure-fixing the unfixed toner image 32 to the member 31 to be recorded, and two pressurizing rollers 35 and 35 turning the pressurizing belt 34 so as to press to the fixing roller 33 by a desired force. In the image fixing apparatus according to embodiment 13, pressuring body is constructed by the pressurizing belt 34 and the pressurizing roller 35.

In the image fixing apparatus according to embodiment 13, the structure is made such that the member 31 to be recorded is conveyed by the pressurizing belt 34 to a nip portion 29 that is a fixing region so as to be pressurized and fixed, however, the structure may be made such that the member 31 to be recorded is pressed to the fixing roller 33 by the pressurizing roller 35 arranged opposed to the fixing roller 33 so as to be pressurized. Further, in the image fixing apparatus according to embodiment 13, the description is given of the example in which the heating body is constructed by the fixing roller 33, however, the heating body may be constructed by a belt turned by the roller.

As shown in FIG. 22, the heat generation unit 12 having the heat generator 1 is provided in an inner portion of the fixing roller 33. In the heat generation unit 12, the heat generator 1 is a heat source for heating the fixing roller 33, and the heat generator 1 is sealed in the inner portion of the container 6. A tubular reflective portion 36 having an opening is provided around the long container 6 sealing the heat generator 1 therein. The reflective portion 36 is made of stainless steel, and an inner surface thereof is mirror-finished. An opening 36a formed in the reflective portion 36 is extended in parallel to the longitudinal direction of the heat generator 1. The opening 36a of the reflective portion 36 is an opening for radiating the heat radiated from the heat generator 1 toward the nip portion 29 in the fixing region by the fixing roller 33 and the pressurizing belt 34 together with the heat reflected in the inner surface of the reflective portion 36. In the image fixing apparatus according to embodiment 13, the opening of the reflective portion 36 is directed in such a manner that the region heated by the heat generation unit 12 comes to a most upstream side in the conveying direction of the member 31 to be recorded in the nip portion 29. Further, the band surface that is the flat surface side of the band-like heat generator 1 of the heat generation unit 12 is directed to a most upstream side in the conveying direction of the member 31 to be recorded in the nip portion 29.

A description will be given of the structure in which the reflective portion 36 is provided around the heat generation unit 12 in the image fixing apparatus according to embodiment 13, however, the image fixing apparatus according to the present invention may be structured such that the fixing roller 33 around the heat generation unit 12 is heated by the heat generation unit 12 without providing the reflective portion.

In the image fixing apparatus according to embodiment 13, the fixing roller 33 is constructed by a plurality of layers, in such a manner that the heat radiated from the heat generation unit 12 is absorbed efficiently in the fixing roller 33, and can be kept warm. An infrared absorption layer absorbing heat (an infrared ray) from the heat generation unit 12 without reflecting is provided in the inner surface of the fixing roller 33.

In the image fixing apparatus according to embodiment 13, a description will be given of an example in which a single heat generation unit 12 is provided, however, a plurality of heat generation units 12 may be provided. In the case where a plurality of heat generation units 12 are provided, each of center axes which are in parallel to the longitudinal direction in the heat generation unit 12 is arranged so as to be orthogonal to a conveying direction of the member 31 to be recorded and be on a straight line. The image fixing apparatus in which a plurality of heat generation units 12 are provided in the inner portion of the fixing roller 33 as mentioned above is structured such that the heat generation unit 12 to be supplied power can be selected in correspondence to a size of the member 31 to be recorded. Since the heat generation unit 12 using the image fixing apparatus according to the present invention is the film sheet-like band body, a heat radiation amount from the band surface that is the flat surface portion is very large in comparison with the heat radiation amount from the side surface portion, and a high directivity is provided. Accordingly, in the image fixing apparatus provided with a plurality of heat generation units 12, it is possible to set small a region which is heated in an overlapping manner by the adjacent heat generation units 12, and it is possible to heat a portion near the nip efficiently and uniformly.

Further, in the image fixing apparatus according to embodiment 13, since the film sheet-like heat generator 1 used in the heat generation unit 12 has a high directivity as mentioned above, and the excellent rising edge characteristic is provided, regardless of the single number or the plural number of the heat generation unit 12 being provided, it is possible to carry out the image fixing process in the image forming process with high efficiency and at a high speed.

In the heat generation unit 12 of the image fixing apparatus according to embodiment 13, the film sheet-like elongated band-like heat generator 1 is arranged in the inner portion of the elongated container 6 having the heat resistance. The elongated band-like heat generator 1 is arranged so as to be extended along the longitudinal direction of the container 6. In the heat generation unit 12, the container 6 is formed by the transparent quartz glass tube, and both end portions of the quartz glass tube is deposited like a flat plate and the container 6 is sealed. The argon gas serving as the inert gas is charged in the inner portion of the container storing the heat generator 1 and the like. The inert gas which can be charged in the inner portion of the container is not limited to the argon gas, and the same effect as the present invention can be achieved even by using the nitrogen gas or the mixed gas of the argon gas and the nitrogen gas, the argon gas and the xenon gas, the argon gas and the krypton gas, and the like, in addition to the argon gas, and it is possible to appropriately select the gas in correspondence to the purpose. The inert gas is charged in the inner portion of the container 6 for the purpose of preventing the heat generator 1 that is the carbon-based substance in the inner portion of the container from being oxidized, when being used at a high temperature. As the material of the container 6, it is possible to employ any material having the heat resistance, the insulating property and the heat permeability, and the material can be appropriately selected, for example, from the glass material such as the soda lime glass, the borosilicate glass, the lead glass and the like, the ceramic materials and the like, in addition to the quartz glass.

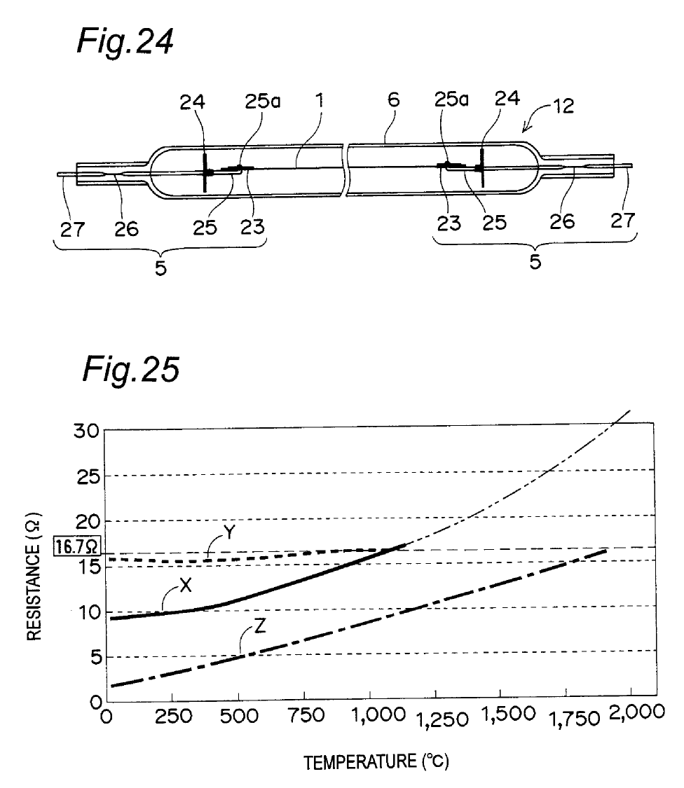

FIG. 23 is a plan view showing the heat generation unit 12 in the image fixing apparatus according to embodiment 13. FIG. 24 is a front view of the heat generation unit 12 in FIG. 23. The structure of the heat generation unit 12 shown in FIGS. 23 and 24 is one example in the heat source of the image fixing apparatus according to the present invention, and the present invention is not limited to this structure. The heat source in the image fixing apparatus according to the present invention includes the film sheet-like heat generator 1 mentioned below, and the other structures in the heat generation unit 12 are appropriately set according to the specification of the product.

As shown in FIGS. 23 and 24, the heat generation unit 12 in the image fixing apparatus according to embodiment 13 is provided with the container 6, the elongated band-like heat generator 1 serving as the heat radiation membrane body, and the power supply portions 5 which are provided in the both end portions in the longitudinal direction of the heat generator 1 for holding the heat generator 1 at the predetermined position within the container and are provided for supplying the power to the heat generator 1.

The power supply portions 5 provided in the both ends of the heat generator 1 include the holders 23, the support rings 24, the internal lead wires 25, the molybdenum foils 26 and the external lead wires 27 which are attached to the both ends of the heat generator 1. The lead wires 25 are fixed to the holders 23, and the internal lead wires 25 are electrically connected to the external lead wires 27 derived out of both ends of the container 6 to the outer portion of the container via the molybdenum foils 26 embedded in the sealed portions (the deposited portions) in the both end portions of the container 6.

As shown in FIGS. 23 and 24, the support ring 24 that is the position regulating portion having the position regulating function is attached to the internal lead wire 25. The internal lead wire 25 is obtained by forming one wire rod, for example, the molybdenum wire in a coil shape.

The internal lead wire 25 according to embodiment 13 are described by the example in which they are formed by the molybdenum wire, however, may be formed by using the metal wire (having the round shape or the flat plate shape) made of tungsten, nickel, stainless steel or the like.

As mentioned above, in the heat generation unit 12 of the image fixing apparatus according to embodiment 13, the power supply portions 5 constructed by the holders 23, the support rings 24, the internal lead wires 25, the molybdenum foils 26 and the external lead wires 27 are provided in the both sides of the heat generator 1, and are provided with the heat generator 1 in a tension manner at a predetermined position within the container as well as supplying the power to the heat generator 1.

The end portion of the heat generator 1 is pinched in the flat surface side and the back surface side by the holder 23, and the through hole formed approximately in the center of the holder 23 and the through hole formed in the end portion of the heat generator 1 are passed through by the end portion of the internal lead wire 25. The internal lead wire 25 is formed in a so-called L-shape by being bent in its heat generator side end portion. The leading end of the L-shaped bent internal lead wire 25 passes through the through hole of the holder 23 pinching (holding) the heat generator 1 so as to protrude.

The fall-out preventing means (the dropout preventing means) is provided in the protruding end portion 25a of the internal lead wire 25 protruding from the through hole of the holder 23. As shown in FIG. 24, the protruding end portion 25a of the internal lead wire 25 is in a state of being plastically deformed by the press working, the melting or the like so as to be crushed. In other words, the protruding end portion 25a in the internal lead wire 25 is worked in a shape larger than the diameter of the through hole of the holder 23, and the fall-out preventing means is provided therein.

The support ring 24 of the heat generation unit 12 is wound around the internal lead wire 25 so as to be fixed, and is formed in the coil shape.

The support ring 24 is structured so as to be wound around and attached to the internal lead wire 25 for supplying the power to the heat generator 1, and is structured such that the current path from the external lead wire 27 to the heat generator 1 does not pass through the support ring 24. In other words, the support ring 24 is structured such that the current path in the internal lead wire 25 is not interposed. As mentioned above, since the support ring 24 is structured such that the current to the heat generator 1 does not flow, the support ring 24 does not generate heat by the current applied to the heat generator 1. The support ring 24 according to embodiment 13 has the position regulating function of the heat generator 1, and serves as the heat dissipation function dissipating the heat conducted from the heat generator 1.

The support ring 24 is described by the example in which it is formed by the molybdenum wire, however, it is possible to use any material as the support ring 24, as long as the material has such a rigidity as to regulate the position of the heat generator 1, has excellent heat conduction (heat dissipation function) and is easy to be processed, for example, the metal material such as nickel, stainless steel, tungsten and the like can be used. It should be noted that the support ring 24 is not a structural element which is always necessary depending on the structure and specification in the heat generation unit 12, such as a length of the heat generator 1, a dimensional difference between an inner diameter of the container 6 and the heat generator 1, and the like.

In the heat generation unit 12, since the material itself of the heat generator 1 has elasticity, and the shape pattern of the heat generator 1 has the elasticity, a mechanism for absorbing the change caused by the expansion and contraction in the heat generator 1 is not necessary. Particularly, since the heat generator 1 used in embodiment 13 has a small coefficient of thermal expansion, the heat generator 1 arranged (provided in the tension manner) in a state where the tensional force is applied at the time of manufacturing can absorb the expansion at the time of generating heat by the elasticity of the heat generator itself and the shape pattern of the heat generator 1.

The heat generator 1 used in the heat generation unit 12 of the image fixing apparatus according to embodiment 13 of the present invention is structured such that each of the layers of a plurality of film sheet raw materials is laminated with each other via an interval in a thickness direction while having the carbon-based substance as the main component, has an excellent two-dimensional isotropic thermal conductivity, and is formed by the film sheet-like material having the coefficient of thermal conductivity equal to or more than 200 W/m·K Accordingly, the band-like heat generator 1 becomes the heat source having no temperature irregularity and uniformly generating heat.

The two-dimensional isotropic thermal conductivity means that the coefficients of thermal conductivity in all the directions are appropriately equal in the surface set by orthogonal X and Y axes. Accordingly, the two-dimensional isotropic property in the present invention does not indicate only one direction (an X-axis direction) that is a carbon fiber direction in the heat generator formed by providing the carbon fibers in line in the same direction, or two directions (the X-axis direction and a Y-axis direction) that is a carbon fiber direction in the heat generator formed by weaving the carbon fibers in cross pattern, for example, but means that the same property is provided in the surface direction in the film sheet-like heat generator 2.

The film sheet raw material that is the material of the heat generator 1 is a high orientation graphite film sheet formed as a graphite by heat treating the high polymer film or the high polymer film to which the filler is added, in the ambient atmosphere at a high temperature, for example, 2400° C. or higher, and sintering, and the coefficient of thermal conductivity in the surface direction is equal to or more than 200 W/m·K, and particularly the coefficient of thermal conductivity of the heat generator 1 according to the present invention shows a characteristic between 600 and 950 W/m·K.

Since the film sheet raw material that is the material of the heat generator 1 used in the present invention is described in detail in embodiment 1 mentioned above, it is described briefly herein. The heat generator 1 is structured such that a plurality of membrane bodies formed by the material including the carbon-based substance are laminated, has an interlayer structure in which a laminating direction is partly attached firmly, and is a film sheet raw material having flexibility in the thickness direction. Accordingly, the film sheet raw material that is the material of the heat generator 1 in the present invention is a material having an excellent two-dimensional isotropic thermal conductivity in which the coefficient of thermal conductivity in the surface direction is uniform.

Further, since the high polymer film used as the film sheet raw material of the heat generator 1, and the filler added to the high polymer film are specifically described in embodiment 1 mentioned above, the description will not be given herein.

The film sheet-like heat generator is manufactured by laminating the film sheet raw material, treating at 2400° C. or higher in the inert gas and regulating the pressure of the gas treatment atmosphere generated in the process of forming graphite. Further, it is possible to obtain a better film sheet-like heat generator by rolling the film sheet-like heat generator manufactured as mentioned above, as necessary. The film sheet-like heat generator manufactured as mentioned above is used as the heat generator 1 in the heat generation unit according to the present invention.

As an adding amount of the filler, a range between 0.2 and 20.0% by weight is preferable, and a range between 1.0 and 10.0% by weight is more preferable. An optimum adding amount is different in accordance with the thickness of the high polymer, a more adding amount is preferable in the case where the thickness of the high polymer is thin, and the adding amount can be reduced in the case where the thickness of the high polymer is thick. A role of the filler is to set the film after the heat treatment to a uniformly foamed state. In other words, the added filler generates the gas during heating, and a cavity after the gas is generated becomes a path so as to assist gentle passage of a cracked gas from the inner portion of the film. The filler serves for preparing the uniform foamed state as mentioned above.

The film sheet raw material manufactured as mentioned above is worked in a desired shape by a trimming die such as a Thomson die and a Pinnacle die, a sharp-edged tool such as a rotary die cutter, or a laser processing or the like.

As shown in FIG. 23, a plurality of cut lines that are current suppressing portions are provided in the heat generating portion of the heat generator 1 according to embodiment 13 so as to extend in a direction which is orthogonal to the longitudinal direction of the heat generator 1. A plurality of current suppressing portions formed in the heat generating portion are structured so as to control the current flowing direction in the heat generating portion and regulate the resistance value. As a shape of the current suppressing portions formed in the heat generating portion, as described in embodiment 1 mentioned above, there are a penetrating groove. (refer to FIG. 4), a closed-end groove (refer to FIG. 5) and the like, in correspondence to the product specification and the intended use in which the heat generation unit 12 is used. Further, in the concave portion groove that is the closed-end groove, it is possible to regulate the resistance value of the heat generating portion by changing a depth in the thickness direction.

Further, by forming the cut line that is the current suppressing portion in the heat generator 1 according to embodiment 13, the heat generator 1 has a characteristic of having great elasticity due to elasticity obtained by forming the cut line along with the elasticity of the heat generator itself.

A description will be given below of a characteristic of the heat generator 1 of the heat generation unit 12 used as the heat source in the image fixing apparatus according to embodiment 13 of the present invention in comparison with the conventional image fixing apparatus.

First, a description will be given of the heat source used in the conventional image fixing apparatus.

A halogen heater used as the heat source in the conventional image fixing apparatus has such an advantage that a rising edge at the time of supplying the power is fast. However, the halogen heater has a great rush current, requires a large-capacity control circuit for turning on and off the halogen heater, and has a problem in cost as well as an enlargement in size of the apparatus. Further, there is such a problem that a fluorescent lamp that is a nearby lighting apparatus flickers (a flicker phenomenon) by controlling the halogen heater.

Further, since the rush current is hardly generated in the carbon heater, the problem that the voltage falls at the time of supplying the power to the heat generator, and the problem that the fluorescent lamp flickers (the flicker phenomenon) are reduced. However, the carbon heater has such problems that it takes a lot of time to rise, it takes a lot of time to carry out the fixing process in the image forming process, and energy consumption at the time of the fixing process is increased.

On the other hand, in the carbon heater using the plate-like heat generator formed by the crystallized carbon such as the black lead and the like, or the mixed material of the resistance value regulating material and the amorphous carbon, since infrared radiation efficiency of the carbon-based substance is high between 78 and 84%, the infrared radiation efficiency from the carbon heater becomes higher by using the carbon-based substance as the heat generator, and it is possible to construct the heat source having high efficiency. However, the heat generator used as the carbon heater is the plate-like heat generator having a thickness (for example, some mm), has a certain degree of great heat capacity, and has such a problem that it takes a lot of time to rise at the time of supplying the power.

Further, the heat generator used as the carbon heater has such a temperature resistance characteristic that the resistance value is approximately constant regardless of the temperature of the heat generator, and the rush current is hardly generated. In the heat generator used as the conventional carbon heater as mentioned above, since the rush current is hardly generated, the problem that the voltage falls at the time of supplying the power to the heat generator, and the problem that the fluorescent lamp flickers (the flicker phenomenon) are reduced. However, in the case where the heat generator is used as the heat source, there are such problems that it takes a lot of time to rise, it takes a lot of time to carry out the fixing process in the image forming process, and the energy consumption is increased at the time of carrying out the fixing process.

The inventors of the present invention have carried out comparative experiments of a temperature characteristic showing a relationship between a temperature [° C.] and a resistance [Ω] by constructing a heater having specification of 100 V and 600 W, in connection with the heat generator 1 of the heat generation unit 12 used in the image fixing apparatus according to embodiment 13 of the present invention, the heater (hereinafter, referred to as the carbon heater for short) using the elongated plate-like heat generator using the carbon-based substance employed as the heat source in the conventional image fixing apparatus as the main component, and the heater (hereinafter, referred to as the halogen heater for short) using the halogen lamp as a reference example.

FIG. 25 is a temperature characteristic diagram showing a relation between the temperature [° C.] and the resistance [Ω] in the heat generator 1 of the heat generation unit 12, the carbon heater that is the conventional heat source, and the halogen heater. In FIG. 25, a solid line X is the temperature characteristic of the heat generator 1 of the heat generation unit 12 used in the image fixing apparatus according to the present invention. Further, in FIG. 25, a broken line Y is the temperature characteristic of the carbon heater, and a one-dot chain line Z is the temperature characteristic of the halogen heater as the reference example.

As shown in FIG. 25, the heat generator 1 of the heat generation unit 12 used in the image fixing apparatus of embodiment 13 according to the present invention has a positive characteristic that the resistance is increased as the temperature becomes higher. According to the experiments, for example, the resistance value was 9.2Ω when the temperature of the heat generator 1 was 20° C. (a non-energized state), and the resistance value was 16.7Ω when the temperature at a balanced lighting state was 1120° C. Accordingly, a rate of change of the resistance value (a rate of resistance change) between the non-energized state and the balanced lighting state of the heat generator 1 is 1.81. The balanced lighting state herein means a state where the power is supplied and the current flows in the heat generator by applying the voltage (for example, 100 V) to the heater, so that the heat generation temperature of the heat generator becomes constant. Further, the rate of resistance change means a value obtained by dividing the value of the resistance at the balanced lighting state brought by energization in the heat generator by the value of the resistance at the non-energized state.

On the other hand, the temperature characteristic of the carbon heater shown by the broken line Y that is the conventional heat generator shows an approximately constant resistance value even if the temperature changes. In accordance with the experiments by the inventors, the resistance value was 15.9Ω when the temperature of the carbon heater was 20° C. (the non-energized state), and the resistance value was 16.7Ω when the temperature at the balanced lighting state was 1030° C. Accordingly, the rate of resistance change between the non-energized state and the balanced lighting state of the carbon heater is 1.05. Further, in the case of the halogen heater shown by the one-dot chain line Z, the resistance value was 1.8Ω when the temperature was 20° C. (the non-energized state), and the resistance value was 16.7Ω when the temperature at the balanced lighting state was 1830° C. Accordingly, the rate of resistance change between the non-energized state and the balanced lighting state of the halogen heater is 9.28.

Even in the case where the power is supplied in such a manner that the temperature at the balanced lighting state is 500° C. by using the heat generator 1 used in the image fixing apparatus according to embodiment 13, the rising characteristic shown by the solid line X in FIG. 25 is obtained, and the resistance value at the time of 500° C. was 11.0Ω. Accordingly, the rate of resistance change between the non-energized state and the balanced lighting state of the heat generator 1 is 1.2 (=11.0/9.2).

Further, in the case where the power is supplied in such a manner that the temperature at the balanced lighting state is 2000° C. by using the heat generator 1 used in the image fixing apparatus according to embodiment 13, the rising characteristic shown by a two-dot broken line continuing from the solid line X in FIG. 25 is obtained, and the resistance value at the time of 2000° C. was 32.2Ω. Accordingly, the rate of resistance change between the non-energized state and the balanced lighting state of the heat generator 1 is 3.5 (=32.2/9.2).

As mentioned above, the heat generator 1 of the heat generation unit 12 used in the image fixing apparatus according to embodiment 13 has a positive characteristic that the resistance is increased as the temperature becomes higher. For example, in the case where the temperature setting at the balanced lighting state is set to 500° C., the resistance value at the balanced lighting state became 11.0Ω and the rate of resistance change was 1.2. Further, in the case where the temperature setting at the balanced lighting state is set to 2000° C., the resistance value at the balanced lighting state became 32.2Ω and the rate of resistance change was 3.5, whereby the temperature and the resistance value show an approximately proportional characteristic.

Further, in the heat generator 1 of the heat generation unit 12 used in the image fixing apparatus according to embodiment 13, the rate of resistance change obtained by dividing the resistance value at the balanced lighting state brought by rated energization by the resistance value at the non-energized state was 1.81. As mentioned above, the heat generator 1 of the heat generation unit 12 used in the image fixing apparatus according to the present invention has a certain degree of resistance (9.2Ω) even at the non-energized state, and the rate of resistance change between the non-energized state and the balanced lighting state is 1.81.

The heat generator 1 of the heat generation unit 12 according to the present invention can precisely generate heat at a desired temperature by setting the power or the heater temperature in such a manner that the rate of resistance change is in a range between 1.2 and 3.5, and has an effect of quickening the rising edge at the time of generating heat, without generating any great rush current when the heat generation unit 12 is turned on. When the rate of resistance change between the non-energized state and the balanced lighting state is within the range between 1.2 and 3.5, the rising edge at the time of generating heat becomes faster, and the device for controlling the heat generation unit 12 does not require a great capacity as mentioned below. In the case of using the heat generator in which the rate of resistance change is less than 1.2, there is obtained the image fixing apparatus in which the temperature is low, the rush current is small and the rising edge is slow. On the other hand, in the case of using the heat generator in which the rate of resistance change exceeds 3.5, a large rush current is generated, and it is necessary to set large an allowable margin of each of the structural elements for securing reliability, so that the capacity of the structural element is increased, and there is generated such a problem that the manufacturing cost is increased and the apparatus is enlarged in size.

On the other hand, in the case of using the carbon heater as the heat source, since the resistance value is approximately constant regardless of the temperature, the rush current is not generated at the time of lighting, and an approximately constant current flows. Accordingly, in the case of using the carbon heater as the heat source, a climbing speed (a rising edge) of a heat generating temperature is slow, and there is such a problem that it takes a lot of time to reach a predetermined temperature. Accordingly, in the case of being used as the heat source of the image fixing apparatus, there are such problems that it takes a lot of time until the nip portion comes to a desired temperature, it takes a lot of time to carry out the image fixing process, and it takes a lot of time to perform a so-called quick start.

A specific resistance value of the heat generator 1 of the heat generation unit 12 is 250 μΩ·cm, a specific resistance value of the carbon of the carbon heater is 3000 to 50000 μΩ·cm, and a specific resistance value of the tungsten of the halogen heater is 5.6 μΩ·cm. As mentioned above, since the specific resistance value of the carbon is very high in comparison with the materials of the other heaters, it is possible to design such that the rush current is hard to be generated at the time of supplying the power as well as designing such that the current change is small. Further, although the specific resistance value of the heat generator 1 is smaller than the specific resistance value of the carbon, it is larger than the specific resistance value of the tungsten, designing is easy in the heat generator 1 in comparison to the heat generator of the tungsten.

Further, a density of the heat generator 1 of the heat generation unit 12 is between 0.5 and 1.0 g/m³ (which is different in accordance with the thickness), a density of the carbon of the carbon heater is 1.5 g/m³, and a density of the tungsten of the halogen heater is 19.3 g/m³. As mentioned above, it is understood that since the density of the heat generator 1 is lighter in comparison with the materials of the other heaters, and since the heat generator 1 is constructed by the elongated band-like thin membrane body, the heat capacity is very small in comparison with the other heaters, and the rising edge becomes fast.

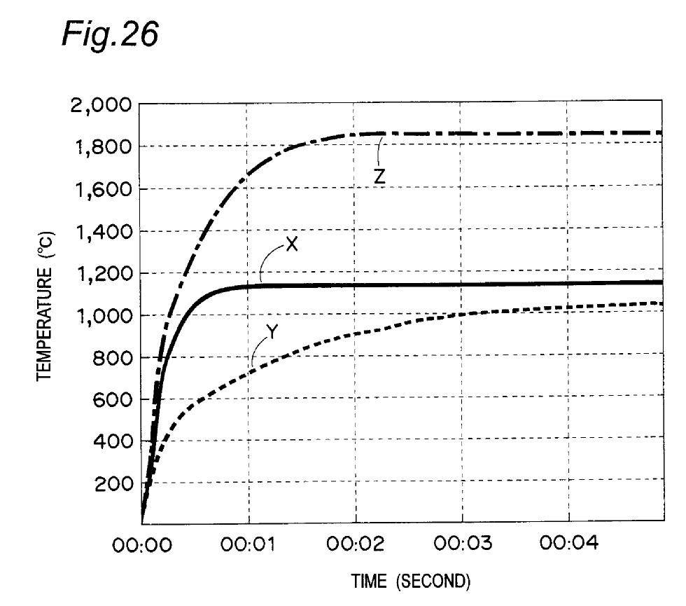

FIG. 26 is a graph showing a result obtained by searching the rising characteristics of the heat generation unit 12 used in the image fixing apparatus according to the present invention, and the carbon heater and the halogen heater which are the conventional heaters.

In FIG. 26, a solid line X is a rising characteristic of the heat generation unit 12 used in the image fixing apparatus according to the present invention. Further, in FIG. 26, a broken line Y is a rising characteristic of the carbon heater using the elongated plate-like, heat generator having the carbon-based substance mentioned above as the main component, and a one-dot chain line Z is a rising characteristic of the halogen heater using the halogen lamp. In the characteristic diagrams shown in FIG. 26, there are shown the rising characteristics from the lighting to five seconds later by using the heaters having the structure of the specification of 100 V and 600 W.

As can be seen from the respective rising characteristics in FIG. 26, the rising characteristic (the solid line X in FIG. 26) of the heat generation unit 12 used in the image fixing apparatus according to the present invention shows a faster rising edge in comparison with the rising characteristic of the carbon heater (the broken line Y in FIG. 26) that is the conventional heat source. In accordance with the experiments by the inventors, a 90% arrival time of the temperature at the balanced lighting state was 0.6 seconds in the heat generation unit 12, where it was 2.7 seconds in the carbon heater. Further, a 90% arrival time in the case of the halogen heater was 1.1 seconds.

As mentioned above, since the rising time to the balanced lighting state is different in the heat generation unit 12, the carbon heater and the halogen heater, the power consumed for the rising time greatly differs. For example, on the assumption that 6 A is consumed in spite that the current changes at the starting time in each of the heaters used in the experiments mentioned above, since a time until the temperature at the balanced lighting state reaches 90% is 0.6 seconds in the heat generation unit 12, power consumption for the time is about 360 W·S. On the other hand, since a time until the temperature at the balanced lighting state reaches 90% is 2.7 seconds in the carbon heater, power consumption for the time is about 1620 W·S. Further, since a time until the temperature at the balanced lighting state reaches 90% is 1.1 seconds in the halogen heater, power consumption for the time is about 600 W·S.

As mentioned above, the power consumption until the balanced lighting state in the heat generation unit 12 is substantially smaller in comparison with the other heaters. Accordingly, since the fixing process is frequently carried out and the on and off operation is repeated in the image fixing apparatus, the difference of the power consumption becomes very large, and the energy consumption is greatly reduced.

The arrival time is comparatively short in the halogen heater because the resistance value at the non-energized state is low, and the great rush current is generated at an early state of the power supply, as shown in FIG. 25. The power consumption in the halogen heater mentioned above is calculated on the assumption that 6 A is consumed, however, since the great rush current flows actually in a stable period between 0 and 5 seconds in an early state of the power supply of the halogen heater, the power consumption for the period becomes a greater value.

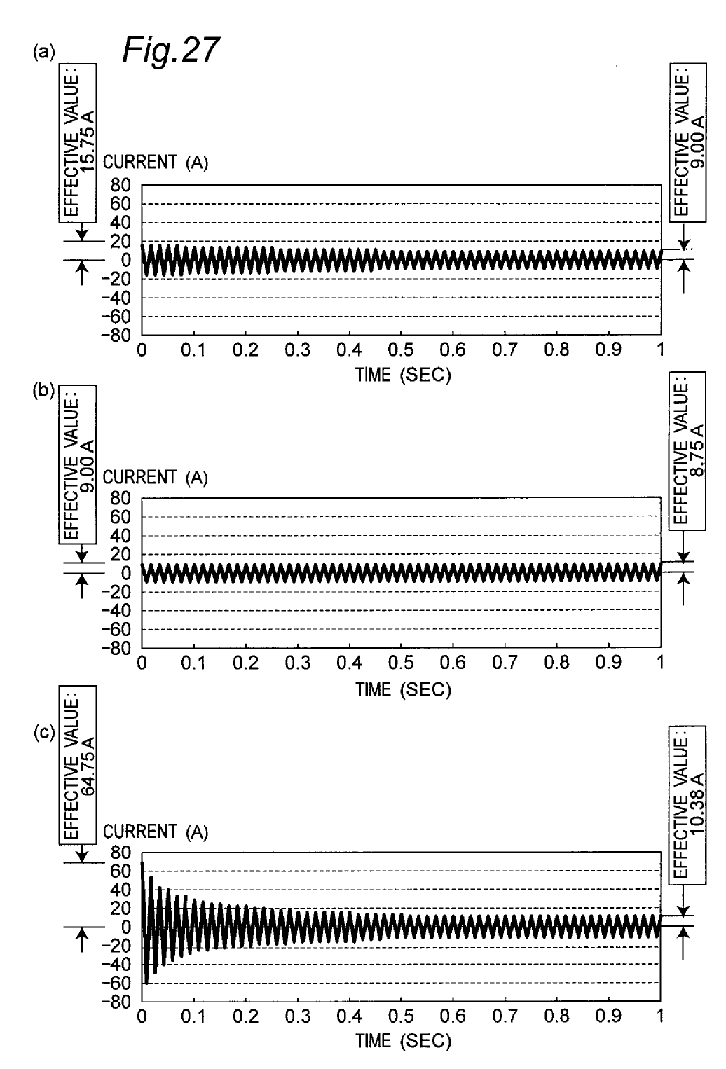

FIGS. 27(a) to 27(c) are views comparing the rush current at an early stage of the power supply in each of the heaters, and shows a current waveform from the early stage of the power supply to 1.0 second later. In FIGS. 27(a) to 27(c), FIG. 27(a) is a current waveform at the time when the heat generation unit 12 used in the image fixing apparatus according to the present invention rises, FIG. 27(b) is a current waveform when the conventional carbon heater rises, and FIG. 27(c) is a current waveform when the halogen heater rises.

As shown in FIG. 27(a), in the heat generation unit 12 used in the image fixing apparatus according to the present invention, an effective value of the current at the early stage of supplying the power was 15.75 A, and an effective value of the current 1.0 second after the early stage of supplying the power was 9.00 A. In other words, the generation of the rush current is recognized in the heat generation unit 12, however, a magnitude thereof is equal to or less than twice the magnitude of the current at the balanced lighting state.

In the case of the carbon heater shown in FIG. 27(b), the rush current was hardly generated, the effective value of the current at the early state of supplying the power was 9.00 A, and the effective value of the current 1.0 second after the early state of supplying the power was 8.75 A. On the other hand, in the case of the halogen heater shown in FIG. 27(c), a great rush current was generated, the effective value of the current at the early stage of supplying the power was 64.75 A, and the effective value of the current 1.0 second after the early stage of supplying the power was 10.38 A. Since the halogen heater has a value five times or more greater than the rate of resistance change between the non-energized state and the balanced lighting state is 9.27 as shown in FIG. 25 mentioned above, the great rush current is generated. The generation of the great rush current as mentioned above has such a characteristic that the rising edge becomes fast, and also has such a problem that it is necessary to use the large capacity element which can stand the great current in the device using the halogen heater. For example, a thyristor serving as a switching element requires a great current capacity, and it is necessary to use a contact point having a great interrupting capacity in such a manner as to prevent a mechanical contact point from being deposited by a great current. Further, since it is hard to carry out the voltage control in the halogen heater in accordance with its heat generating principle (a halogen cycle), and the halogen heater only carries out on-off switching control, there is such a problem that the temperature cannot be accurately controlled.

As mentioned above, since the heat generation unit 12 used in the image fixing apparatus according to the present invention has such a characteristic that the rate of change between the non-energized state and the balanced lighting state is 1.81, and a certain degree of rush current is generated, the rising edge becomes fast, the time until the balanced lighting state becomes short, and it becomes a heat source having an excellent response. Accordingly, since the heat generation unit 12 is used as the heat source of the image fixing apparatus, it is possible to enhance the performance as the image fixing apparatus, and it is possible to provide an apparatus which can save energy while having reduced energy consumption.

Further, since the heat generation unit 12 used in the image fixing apparatus according to the present invention has such a characteristic that does not generate any great rush current as the halogen heater, it is not necessary to use a large-capacity structure which can stand a large current for the apparatus using the heat generation unit 12, and it is possible to achieve a reduction of a manufacturing cost and downsizing. The great rush current herein means that the current at an early stage of supplying the power is five times or more than the current 1.0 second after the early stage of supplying the power.

In the heat generation unit 12 used in the image fixing apparatus according to the present invention, the current at the early stage of supplying the power becomes equal to or less than 3.5 times of the current 1.0 second after the early stage of supplying the power. As mentioned above, the heat generation unit 12 becomes a heat source having an early rising edge and having an excellent response by setting such that the current at the early stage of supplying the power becomes equal to or less than 3.5 times of the current 1.0 second after the early stage of supplying the power. Further, it is not necessary to use a large capacity structure which can stand a large current for the apparatus using the heat generation unit 12, in the heat generation unit 12, and it is possible to achieve a reduction of the manufacturing cost and downsizing of the apparatus.

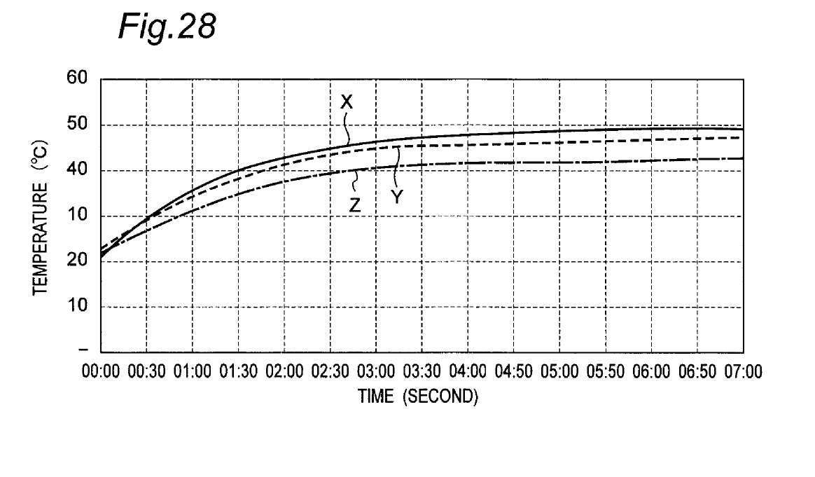

FIG. 28 shows a result of measurement of a copper plate temperature when heating a copper plate as the object to be heated by each of the heaters including the heat generation unit 12, the carbon heater and the halogen heater. In FIG. 28, a solid line X is a temperature rising curve of the copper plate by the heat generation unit 12, a broken line Y is a temperature rising curve of the copper plate by the carbon heater, and a one-dot chain line Z is a temperature rising curve of the copper plate by the halogen heater.

In the copper plate temperature measuring experiments shown in FIG. 28, the copper plate piece as the object to be heated having a dimension of 65 mm (L)×65 mm (W)×0.5 mm (t) was used, and black paint was applied to a heating surface opposed to the heater that is the heating body. Each of the heaters is a long heater having a length of 300 mm, and a structure having the specification of 100 V and 600 W was used. An opposed distance between the copper plate and the heater was 300 mm, and a thermo couple was attached to a back surface that is the opposed side to the heating surface of the copper plate piece so as to measure the copper plate temperature.

As shown in FIG. 28, the heat generation unit used in the image fixing apparatus according to the present invention raises the temperature of the copper plate as the object to be heated in a quickest manner and heats to a high temperature, in spite of the same specification in comparison with the other heaters. The tungsten wire as the heat generating body comes to a high temperature in the halogen heater, however, radiation efficiency of the tungsten is low (about 0.18), and the temperature rise of the object to be heated is slow. The temperature rise of the carbon heater is quicker than the temperature rise of the halogen heater, however, it is slower than the temperature rise of the heat generation unit 12, and a balancing temperature is low. This is because the radiation efficiency of the heat generator 1 of the heat generation unit 12 is as high as 0.9 in comparison with the radiation efficiency 0.85 of the carbon. Accordingly, it can be understood that the heat generation unit 12 used in the image fixing apparatus according to the present invention can heat the object to be heated efficiently and quickly.

As mentioned above, the heat generator 1 used in the image fixing apparatus according to embodiment 13 has such an excellent characteristic that the heat capacity is small while being light and thin, and the rising edge to the balanced lighting state by energization is early. Accordingly, in the image fixing apparatus according to embodiment 13, since there is employed the heat generation unit 12 having the heat generator which has an excellent response and heats highly efficiently, it is possible to quickly heat the fixing region, it is possible to achieve energy saving, and it is possible to realize a quick start. Further, in the image fixing apparatus according to embodiment 13, since the great rush current is not generated at the lighting state in the early stage of heating, it is possible to solve such a problem that a voltage drop is generated, and a flicker of the fluorescent lamp is generated.

### INDUSTRIAL APPLICABILITY

Since the heat generation unit according to the present invention has the effect that it is easy to regulate the resistance value of a whole of the heat generator, and the temperature dispersion in the heat generator becomes small, it is useful as the heat source, is used in various apparatuses such as the heating apparatus for heating purpose, the OA device such as the copying machine and the printer, the heating cooking device, the drying machine, the humidifier and the like, and has a high general-purpose property.

1. A heat generation unit comprising:
a heat generator generating heat by a voltage applied to both ends thereof in a longitudinal direction;
a holder holding the end portion of the heat generator;
a power supply portion supplying power to the both ends of the heat generator; and
a container including therein the heat generator, the holder and the power supply portion,
wherein the heat generator having an elongated sheet-like shape is configured to be made by a carbon-based substance as a main component, the carbon-based substance is obtained by firing a high polymer film or a high polymer film with a filler such that a plurality of layers are laminated while forming an interval with each other in a thickness direction, and a current suppressing portion controlling a current flowing in each of the laminated layers is formed in the heat generator.

2. The heat generation unit according to claim 1, wherein the current suppressing portion is constructed by a cut line in a direction which is orthogonal to a layer surface of the heat generator, and is formed in such a manner as to suppress the current flowing in a longitudinal direction of the heat generator.

3. The heat generation unit according to claim 2, wherein the current suppressing portion has a pair of first current suppressing portions extended from both opposed side edges of the heat generator toward edges opposed to each other in the heat generator, opposed end portions of the pair of first current suppressing portions are arranged so as to have a predetermined distance, and plural sets of the pair of first current suppressing portions are arranged along the longitudinal direction so as to have a predetermined distance.

4. A heat generation unit comprising:
an elongated sheet-like heat generator generating heat by a voltage applied to both ends thereof in a longitudinal direction and having a carbon-based substance as a main component;
a holder holding the end portion of the heat generator;
a power supply portion supplying power to the both ends of the heat generator; and
a container including therein the heat generator, the holder and the power supply portion,
wherein the heat generator is configured such that a plurality of layers are laminated while forming an interval with each other in a thickness direction, and a current suppressing portion controlling a current flowing in each of the laminated layers is constructed by a cut line in a direction which is orthogonal to a layer surface of the heat generator, and the current suppressing portion is formed in such a manner as to suppress the current flowing in a longitudinal direction of the heat generator,
wherein the current suppressing portion has a pair of first current suppressing portions extended from both opposed side edges of the heat generator toward edges opposed to each other in the heat generator, opposed end portions of the pair of first current suppressing portions are arranged so as to have a predetermined distance, and plural sets of the pair of first current suppressing portions are arranged along the longitudinal direction so as to have a predetermined distance, and
wherein a portion between the opposed end portions of the pair of first current suppressing portions becomes a center side conduction path having a predetermined width in a band width direction which is orthogonal to the longitudinal direction, and the center side conduction path becomes a current path in which the current flows along the longitudinal direction.

5. The heat generation unit according to claim 2, wherein the current suppressing portion has a first current suppressing portion extended from one edge of both opposed side edges of the heat generator toward the other edge of the heat generator, and a first current suppressing portion extended from the other edge of the both side edges toward the one edge, and the first current suppressing portions are arranged alternately so as to have a predetermined distance along the longitudinal direction.

6. The heat generation unit according to claim 4, wherein the current suppressing portion is structured such as to have a second current suppressing portion formed between the first current suppressing portions which are formed in plural sets while having a predetermined distance along the longitudinal direction, the first current suppressing portion and the second current suppressing portion are arranged alternately in the longitudinal direction, the second current suppressing portion is formed in such a manner that portions between both end portions thereof and the both side edges of the heat generator respectively become edge side conduction paths having predetermined distances, and the edge side conduction path becomes a current path in which a current flows along the longitudinal direction.

7. The heat generation unit according to claim 6, wherein the second current suppressing portion is formed in such a manner as to become shorter in accordance with coming close to the holder, near the end portion of the heat generator pinched by the holder, and a width of the edge side conduction path becomes wider in accordance with coming close to the holder.

8. The heat generation unit according to claim 6, wherein a center portion near the center line in the heat generator is provided with a third current suppressing portion which intersects the second current suppressing portion, and is extended in the longitudinal direction.

9. A heat generation unit comprising:
an elongated sheet-like heat generator generating heat by a voltage applied to both ends thereof in a longitudinal direction and having a carbon-based substance as a main component;
a holder holding the end portion of the heat generator;
a power supply portion supplying power to the both ends of the heat generator; and
a container including therein the heat generator, the holder and the power supply portion,
wherein the heat generator is configured such that a plurality of layers are laminated while forming an interval with each other in a thickness direction, and a current suppressing portion controlling a current flowing in each of the laminated layers is constructed by a cut line in a direction which is orthogonal to a layer surface of the heat generator, and the current suppressing portion is formed in such a manner as to suppress the current flowing in a longitudinal direction of the heat generator,
wherein the current suppressing portion comprises
a first current suppressing portion extended from one edge of both opposed side edges of the heat generator toward the other edge of the heat generator; and
a third current suppressing portion coming into contact with the first current suppressing portion, and extended in the longitudinal direction, and
wherein a plurality of the first current suppressing portions and the third current suppressing portions are arranged at a predetermined distance along the longitudinal direction.

10. A heat generation unit comprising:
an elongated sheet-like heat generator generating heat by a voltage applied to both ends thereof in a longitudinal direction and having a carbon-based substance as a main component;
a holder holding the end portion of the heat generator;
a power supply portion supplying power to the both ends of the heat generator; and
a container including therein the heat generator, the holder and the power supply portion,
wherein the heat generator is configured such that a plurality of layers are laminated while forming an interval with each other in a thickness direction, and a current suppressing portion controlling a current flowing in each of the laminated layers is constructed by a cut line in a direction which is orthogonal to a layer surface of the heat generator, and the current suppressing portion is formed in such a manner as to suppress the current flowing in a longitudinal direction of the heat generator,
wherein the current suppressing portion comprises
a second current suppressing portion extended so as to intersect in the longitudinal direction, and formed in such a manner as to have a predetermined distance with respect to the both side edges; and
a third current suppressing portion coming into contact with the second current suppressing portion, and extended in the longitudinal direction, and
wherein a plurality of the second current suppressing portions and the third current suppressing portions are arranged so as to have a predetermined distance along the longitudinal direction.

11. The heat generation unit according to claim 9, wherein the current suppressing portion has the first current suppressing portion extended from the both opposed side edges of the heat generator toward the edges opposed to each other of the heat generator and formed in the both side edge sides of the heat generator while having a predetermined distance along the longitudinal direction, and a third current suppressing portion coupled to a center side end portion of the first current suppressing portion and extended so as to have a predetermined length in the longitudinal direction, and
wherein opposed regions of the third current suppressing portion become a center side conduction path, and the center side conduction path becomes a current path in which the current flows along the longitudinal direction.

12. The heat generation unit according to claim 10, wherein a plurality of current suppressing portions each having the second current suppressing portion, and the third current suppressing portion coupled to both end portions of the second current suppressing portion so as to be extended in the longitudinal direction are arranged so as to have a predetermined distance along the longitudinal direction, whereby a row is constructed, the current suppressing portions are arranged in a single row or a plurality of rows in the longitudinal direction, a region between the third current suppressing portion and the edge of the heat generator, or a region between the rows when a plurality of rows are arranged is formed so as to become a conduction path having a predetermined distance, and the conduction path becomes a current path in which the current flows along the longitudinal direction.

13. The heat generation unit according to claim 11, wherein the first current suppressing portions formed in the both opposed side edge sides of the heat generator are formed alternately in the longitudinal direction in place of opposed positions, and the third current suppressing portions in both sides coupled to the first current suppressing portions so as to form the center side conduction path are formed alternately in the longitudinal direction in place of the opposed positions.

14. The heat generation unit according to claim 11, wherein on an assumption that an adjacent distance in the longitudinal direction of the first current suppressing portions provided on the same edge is set to L2, and a distance between adjacent end portions of the end portions extended in the longitudinal direction of the third current suppressing portion is set to L1, a relationship between L1 and L2 is a range that L1/L2 equals to or more than 0.2 and equals to or less than 0.9.

15. The heat generation unit according to claim 11, wherein in a region near the holder in the heat generator, the third current suppressing portion is coupled to the center side end portion of the first current suppressing portion via a fourth current suppressing portion, the fourth current suppressing portion is formed so as to be inclined with respect to the longitudinal direction, and the center side conduction path in the region near the holder is constructed to be wider.

16. The heat generation unit according to claim 4, wherein in a region near the holder in the heat generator, a distance between the opposed end portions of the pair of first current suppressing portions is formed in such a manner as to become shorter in accordance with coming close to the holder, and a width in a band width direction of the center side conduction path pinched by the opposed end portions of the pair of first current suppressing portions is constructed in such a manner as to become wider in accordance with coming close to the holder.

17. The heat generation unit according to claim 1, wherein the heat generator has a two-dimensional isotropic thermal conductivity in a layer surface direction.

18. The heat generation unit according to claim 1, wherein the heat generator is structured such that plural layers of film sheet raw materials are laminated, and is formed in a sheet shape having a thickness equal to or less than 300 μm.

19. The heat generation unit according to claim 1, wherein the container is constructed by any one of a glass tube having a heat resistance and a ceramic tube, and is constructed by charging an inert gas into the container.

20. A heating apparatus using the heat generation unit according to claim 1 as a heat source.

21. An image fixing apparatus comprising:
a heating body heating a member to be recorded in which an unfixed toner image is carried; and
a pressurizing body arranged so as to be opposed to the heating body and pressurizing the heating body via the member to be recorded,
wherein the heating body has a heat generator as a heat source, the heat generator having an elongated sheet-like shape is configured to be made by a carbon-based substance as a main component, the carbon-based substance is obtained by firing a high polymer film or a high polymer film with a filler such that a plurality of layers are laminated while forming an interval with each other in a thickness direction, and the heat generator has a two-dimensional isotropic thermal conductivity.

22. (canceled)

23. The image fixing apparatus according to claim 21, wherein the heat generator has such a positive characteristic that a value of a rate of resistance change obtained by dividing a value of a resistance at a balanced lighting state brought by energization by a value of a resistance at a non-energized state is in a range between 1.2 and 3.5, and a temperature of the heat generator and the resistance value are proportional.

24. The image fixing apparatus according to claim 23, wherein the heat generator is constructed by a thin membrane body in which a thickness is equal to or less than 300 μm.

25. The image fixing apparatus according to claim 23, wherein the heat generator is constructed by a light membrane body in which a density is equal to or less than 1.0 g/cm³.

26. The image fixing apparatus according to claim 23, wherein the heat generator is formed by a material in which a coefficient of thermal conductivity is equal to or more than 200 W/m·K.

27. The image fixing apparatus according to claim 23, wherein the heating body has a container storing a part of a power supply portion supplying power in both opposed ends of the heat generator together with the heat generator, and the container is structured such as to be filled with an inert gas in an inner portion and be sealed in the power supply portion.

28. The image fixing apparatus according to claim 23, wherein the heating body is provided with a reflective portion for defining a heating region by the heat generator.

29. The image fixing apparatus according to claim 23, wherein the heating body is provided with a plurality of the heat generators, and respective center axes in a longitudinal direction in the plurality of heat generators are arranged on a straight line so as to be orthogonal to a conveying direction of the member to be recorded.

30. The image fixing apparatus according to claim 23, wherein the membrane body is formed by a member absorbing an infrared ray in an opposed surface to the heat generator, in the heating body.

31. The image fixing apparatus according to claim 23, wherein the heating range of the heat generator includes a nip portion as a pressing position of the member to be recorded by the heating body and the pressurizing body, and an upstream side position in the conveying direction of the member to be recorded by the nip portion.

32. An image forming apparatus comprising the image fixing apparatus according to claim 21.
